(19) United States
(12) Patent Application Publication
(10) Pub. No.: US 2013/0064252 A1
(43) Pub. Date: Mar. 14, 2013

(54) SIGNAL TRANSMISSION/RECEPTION CIRCUIT

(71) Applicant: Tsugio TAKAHASHI, Tokyo (JP)

(72) Inventor: Tsugio TAKAHASHI, Tokyo (JP)

(73) Assignee: NEC CORPORATION, Tokyo (JP)

(21) Appl. No.: 13/598,105

(22) Filed: Aug. 29, 2012

(30) Foreign Application Priority Data
Sep. 14, 2011 (JP) 2011-200789

(51) Int. Cl. H04J 13/00

(52) U.S. Cl. 370/479

(57) ABSTRACT

The code word generation section generates a code word by adding an error checking and correcting code to an word. The conversion section divides the code words into bit strings each including information bits having the same number of bits as that of the word and code bits having the same number of bits as that of the error checking and correction code, and for each of the bit strings, outputs the information bits of the bit string to a first signal line group and outputs the code bits to a second signal line group. When dividing the code words into the bit strings, the code words are divided in such a manner as to satisfy a condition that a plurality of bits of the same code word are not output at the same time on a particular signal line group.

This application is based upon and claims the benefit of priority from Japanese patent application No. 2011-200789, filed on Sep. 14, 2011, the disclosure of which is incorporated herein in its entirety by reference.

### TECHNICAL FIELD

The present invention relates to a signal transmission/reception circuit including a signal transmission circuit and a signal reception circuit connected with each other by a plurality of signal lines, and in particular, to a signal transmission/reception circuit which transmits and receives data with the addition of error checking and correcting codes to the data.

### BACKGROUND ART

A signal transmission/reception circuit which transmits and receives data, in which a signal transmission side transmits data with the addition of error checking and correcting codes to the data and a signal reception side checks and corrects errors in the received data using the error checking and correcting codes, has been known (for example, see JP 62-501047 A (Patent Document 1)).

FIG. 23 shows an exemplary format of signals transmitted and received in a signal transmission/reception circuit. In this example, a 3-bit ECC (Error Checking and Correcting) code is added to a 4-bit word to thereby form a code word of 7 bits in total, and respective code words are transmitted and received in units of code words with use of seven signal lines. In this case, by using a hamming code as an ECC code, for example, a 1-bit error in a word can be corrected.

On the other hand, in a video signal transmission device which performs serial transmission by multiplexing digital sound signals with video signals, a technique of adding an error checking and correcting code to each predetermined number of pieces of data of a digital sound signal and then reordering the bits, has been known (for example, see JP 5-219488 A (Patent-Document 2)). Specifically, the video signal transmission device disclosed in Patent Document 2 performs writing on a bit-by-bit basis serially into a memory of m×n cells in a row direction, and then performs reading by changing the direction to a column direction.

Patent Document 1: JP 62-501047 A

Patent Document 2: JP 5-219488 A

When data is transmitted between LSIs, the probability of occurrence of errors due to simultaneous switching noise is higher than the probability of soft errors. Simultaneous switching noise is noise generated in a power supply line when a plurality of drivers are switched simultaneously in the same logical direction (for example, in a direction from 0 to 1). When simultaneous switching noise is generated in a power supply line, errors may occur simultaneously in a plurality of signal lines which are receiving power supply from the power supply line. As such, as shown in the signal format of FIG. 23, in a signal transmission/reception circuit in which an error checking and correcting code is added to each word to thereby generate a code word, and transmission is performed in units of code words, if simultaneous switching noise is generated, the probability that an uncorrectable error of 2 bits or more occurs in the same code word would be high.

Meanwhile, as disclosed in Patent Document 2, in the case of performing writing on a bit-by-bit basis serially into a memory of m×n cells in a line direction for a given number of code words, and then performing reading by changing the direction to a column direction, if “m” and “n” are set to be the same as the number of bits of a code word, the signal format as shown in FIG. 23 can be transmitted by being converted into the signal format as shown in FIG. 24. In the signal format of FIG. 24, as the number of bits transmitted at a given time is 1 bit in every code word, even if simultaneous switching noise is generated and an error occurs in every bit on the signal line, an error in each code word is mere 1 bit. As such, the error is correctable in every code word. However, in the signal format of FIG. 24, the entire bits of the same code word are transmitted via the same signal line. As such, if multiple errors occur in any one of the signal lines due to performance degradation caused by aging of an input/output buffer amplifier provided to each signal line, for example, the possibility that uncorrectable errors of 2 bits or more occur in the same code word would be high.

### SUMMARY

An exemplary object of the present invention is to provide a signal transmission/reception circuit capable of solving the above-described problem, that is, a problem that it is difficult to ensure error correction capability with respect to both simultaneous switching errors and multiple errors on a particular signal line.

A signal transmission and reception circuit, according to an exemplary aspect of the present invention, includes a signal transmission circuit and a signal reception circuit connected with each other by a first signal line group and a second signal line group.

The signal transmission circuit includes:

a code word generation section that generates a code word by adding an error checking and correcting code to an input word; and

a conversion section that divides a plurality of code words generated by the code word generation section into bit strings each including information bits having the number of bits which is the same as the number of bits of the word and code bits having the number of bits which is the same as the number of bits of the error checking and correcting code, and for each of the bit strings, outputs the information bits of the bit string to the first signal line group and outputs the code bits of the bit string to the second signal line group, wherein when dividing the code words into the bit strings, the conversion section divides the code words in such a manner as to satisfy a condition that a plurality of bits of the same code word are not output at the same time within the range of the first signal line group and the second signal line group or the range of a partial signal line group included in the first signal line group and the second signal line group, and that the respective bits of the error checking and correcting code of the same code word are output to different signal lines of the second signal line group, respectively, and

the signal reception circuit includes:

an inversion section that reorders the bit strings received from the first signal line group and the second signal line group to reproduce the code words in each of which the error checking and correcting code is added to the word; and

an error correction section that performs error correction of the word with use of the error checking and correcting code included in the code word reproduced by the inversion section, and outputs the word to the outside in the word unit.

Further, a signal transmission circuit, according to another exemplary aspect of the present invention, is a signal transmission circuit connected with a first signal line group and a second signal line group, including:

a code word generation section that generates a code word by adding an error checking and correcting code to an input word; and

a conversion section that divides a plurality of code words generated by the code word generation section into bit strings each including information bits having the number of bits which is the same as the number of bits of the word and code bits having the number of bits which is the same as the number of bits of the error checking and correcting code, and for each of the bit strings, outputs the information bits of the bit string to the first signal line group and outputs the code bits of the bit string to the second signal line group, wherein when dividing the code words into the bit strings, the conversion section divides the code words in such a manner as to satisfy a condition that a plurality of bits of the same code word are not output at the same time within the range of the first signal line group and the second signal line group or the range of a partial signal line group included in the first signal line group and the second signal line group, and that the respective bits of the error checking and correcting code of the same code word are output to different signal lines of the second signal line group, respectively.

Further, a signal reception circuit, according to another exemplary aspect of the present invention, is a signal reception circuit that receives bit strings transmitted from the signal transmission circuit according to the above-described aspect via a first signal line group and a second signal line group, including:

an inversion section that reorders the bit strings received from the first signal line group and the second signal line group to reproduce code words in each of which an error checking and correcting code is added to a word; and

an error correction section that performs error correction of the word with use of the error checking and correcting code included in the code word reproduced by the inversion section, and outputs the word to the outside in the word unit.

Further, a signal transmission and reception method, according to another exemplary aspect of the present invention, is a method implemented by a signal transmission and reception circuit including a signal transmission circuit and a signal reception circuit connected with each other by a first signal line group and a second signal line group, the signal transmission circuit including a code word generation section and a conversion section, the signal reception circuit including an inversion section and an error correction section. The method includes:

by the code word generation section, generating a code word by adding an error checking and correcting code to an input word;

by the conversion section, dividing a plurality of code words generated by the code word generation section into bit strings each including information bits having the number of bits which is the same as the number of bits of the word and code bits having the number of bits which is the same as the number of bits of the error checking and correcting code, and for each of the bit strings, outputting the information bits of the bit string to the first signal line group and outputting the code bits of the bit string to the second signal line group, the dividing the code words into the bit strings being performed in such a manner as to satisfy a condition that a plurality of bits of the same code word are not output at the same time within the range of the first signal line group and the second signal line group or the range of a partial signal line group included in the first signal line group and the second signal line group, and that the respective bits of an error checking and correcting code of the same code word are output to different signal lines of the second signal line group, respectively;

by the inversion section, reordering the bit strings received from the first signal line group and the second signal line group to reproduce the code words in each of which the error checking and correcting code is added to the word; and

by the error correction section, performing error correction of the word with use of the error checking and correcting code included in the code word reproduced by the inversion section, and outputs the word to the outside in the word unit.

As the present invention has the configuration described above, it is possible to ensure error correction capability with respect to both simultaneous switching errors and multiple errors which occur on a particular signal line.

### BRIEF DESCRIPTION OF DRAWINGS

FIG. 1 is a block diagram showing a signal transmission/reception circuit according to a first exemplary embodiment of the present invention;

FIG. 2 is a block diagram showing a signal transmission circuit according to a second exemplary embodiment of the present invention;

FIG. 3 is a table showing a format of signals input to the signal transmission circuit according to the second exemplary embodiment of the present invention;

FIG. 4 is a table showing a format of signals output from the signal transmission circuit according to the second exemplary embodiment of the present invention;

FIG. 5 is a block diagram showing a signal reception circuit according to a third exemplary embodiment of the present invention;

FIG. 6 is a block diagram showing a signal transmission circuit according to a fourth exemplary embodiment of the present invention;

FIG. 7 is an illustration of operation of the signal transmission circuit according to the fourth exemplary embodiment of the present invention;

FIG. 8 is a table showing a format of signals output from the signal transmission circuit according to the fourth exemplary embodiment of the present invention;

FIG. 9 is a block diagram showing a signal reception circuit according to a fifth exemplary embodiment of the present invention;

FIG. 10 is a block diagram showing a signal transmission circuit according to a sixth exemplary embodiment of the present invention;

FIG. 11 is a table showing a format of signals output from the signal transmission circuit according to the sixth exemplary embodiment of the present invention;

FIG. 12 is a block diagram showing a signal reception circuit according to a seventh exemplary embodiment of the present invention;

FIG. 13 is a block diagram showing a signal transmission circuit according to an eighth exemplary embodiment of the present invention;

FIG. 14 is an illustration of operation of the signal transmission circuit according to the eighth exemplary embodiment of the present invention;

FIG. 15 is a table showing a format of signals output from the signal transmission circuit according to the eighth exemplary embodiment of the present invention;

FIG. 16 is a block diagram showing a signal reception circuit according to a ninth exemplary embodiment of the present invention;

FIG. 17 is a block diagram showing a signal transmission circuit according to a tenth exemplary embodiment of the present invention;

FIG. 18 is an illustration of operation of the signal transmission circuit according to the tenth exemplary embodiment of the present invention;

FIG. 19 is a table showing a format of signals output from the signal transmission circuit according to the tenth exemplary embodiment of the present invention;

FIG. 20 is a block diagram showing a signal reception circuit according to an eleventh exemplary embodiment of the present invention;

FIG. 21 is a block diagram showing a signal transmission/reception circuit according to a twelfth exemplary embodiment of the present invention;

FIG. 22 is a block diagram showing a signal transmission/reception circuit according to a thirteenth exemplary embodiment of the present invention;

FIG. 23 is a table showing a format of signals output from a signal reception circuit related to the present invention; and

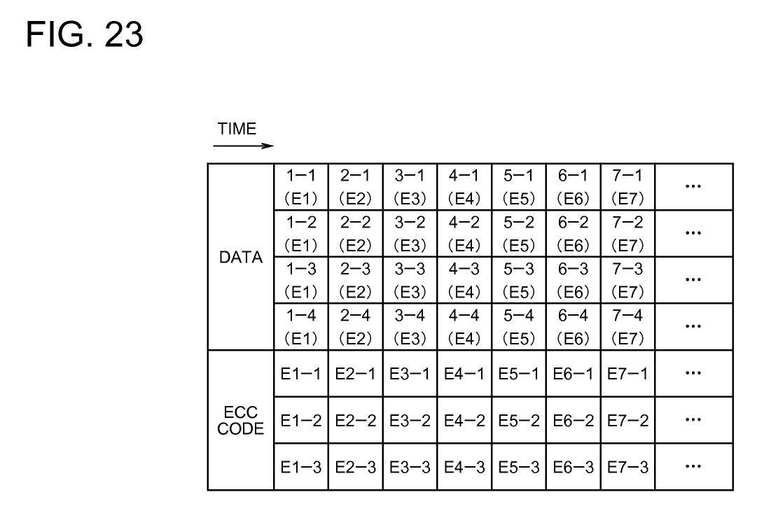

FIG. 24 is a table showing a format of signals output from a signal reception circuit related to the present invention;

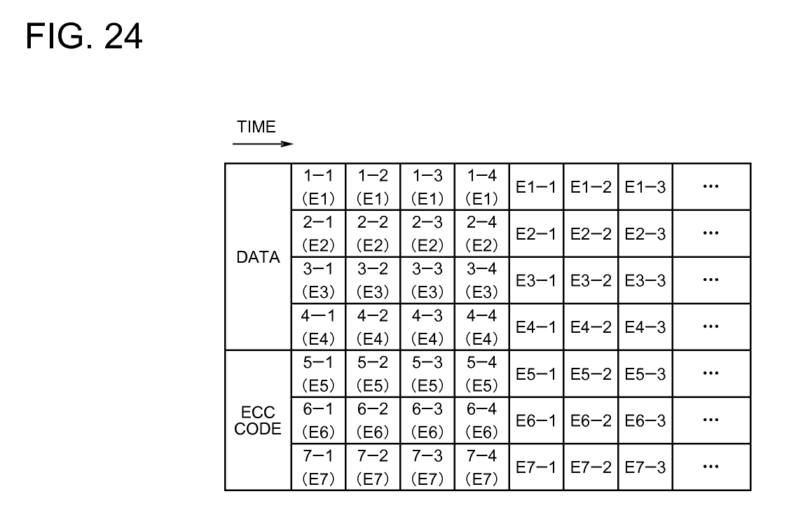

### EXEMPLARY EMBODIMENTS

Next, exemplary embodiments of the present invention will be described in detail with reference to the drawings.

### First Exemplary Embodiment

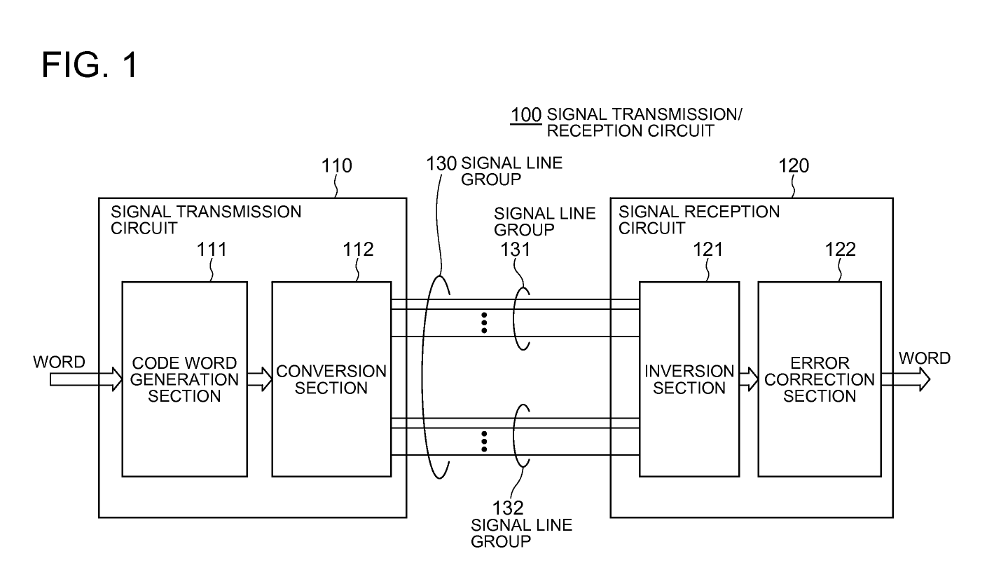

Referring to FIG. 1, a signal transmission/reception circuit 100 according to a first exemplary embodiment of the present invention includes a signal transmission circuit 110, and a signal reception circuit 120 connected with the signal transmission circuit 110 via a signal line group 130. The signal line group 130 consists of a plurality of signal lines. The signal line group 130 includes a signal line group 131 used for transmitting information bits, and a signal line group 132 used for transmitting error checking and correcting (ECC) codes.

The signal transmission circuit 110 has a function of generating a code word by adding, to an input word, an ECC code for correcting an error in the word, and a function of dividing the generated code words into a plurality of bit strings of the same number of pieces and the same number of bits as those of the code words and transmitting them to the signal reception circuit 120 via the signal line group 130. In this step, the signal transmission circuit 110 outputs them in such a manner that a plurality of bits of the same code word are not output to a particular signal line group of the signal line group 130 in parallel at the same time, and that the respective bits of the ECC code of the same code word are output to different signal lines of the signal line group 132, respectively.

In this example, a particular signal line group means a group of signal lines in which the power source of the drive circuits, which drives the signal lines, is the same. Accordingly, in the case of a single power source, the entire signal line group 130 forms one particular signal line group. If the signal line group 131 and the signal line group 132 are respectively connected with drive circuits which are driven by different power sources, each of the signal line group 131 and the signal line group 132 forms one particular signal line group. Further, if the signal line group 131 includes a signal line group connected with drive circuits driven by one power source and a signal line group connected with drive circuits driven by another power source, the signal lines connected with the drive circuits driven by the same power source in the signal line group 131 form one particular signal line group. Generally, in an LSI (Large Scale Integration) and an FPGA (Field Programmable Gate Array), power-supply noise when signals are output is generated almost independently on a power supply basis which is determined by the power supply lines on the chip of the LSI/FPGA, that is, on a power bank basis. As such, there is no need to consider simultaneous switching noise between different power banks. However, this does not prevent such a consideration.

The signal transmission circuit 110 of the present embodiment includes a code word generation section 111 and a conversion section 112.

The code word generation section 111 has a function of generating a code word by adding an ECC code to an input word.

The conversion section 112 has a function of dividing a plurality of code words, generated by the code word generation section 111, into bit strings each including information bits having the same number of bits as that of a word and code bits having the same number of bits as that of an ECC code, and outputting them in units of bit strings to the signal line group 130. The conversion section 112 outputs the information bits of a bit string to the signal line group 131, and outputs the code bits of the bit string to the signal line group 132. Further, the conversion section 112 divides the code words into bits strings in such a manner as to satisfy a condition that a plurality of bits of the same code word (preferably, any 2 bits of the same code word) are not output at the same time within the range of the signal line group 130 or within the range of a partial signal line group constituting the signal line group 130, and that the respective bits of the ECC code of the same code word are output to different signal lines of the signal line group 132, respectively.

The signal reception circuit 120 has a function of receiving a plurality of bit strings from the signal transmission circuit 110 via the signal line group 130, and outputting them to the outside in units of original words. In the present embodiment, the signal reception circuit 120 includes an inversion section 121 and an error correction section 122.

The inversion section 121 has a function of reordering a plurality of bit strings received from the signal line group 130 to reproduce code words each including a word and an ECC code for correcting an error in the word.

The error correction section 122 has a function of performing error correction of a word with use of an ECC code included in a code word reproduced by the inversion section 121, and outputting the word to the outside in the word unit.

In the present embodiment, as an ECC code, a hamming code or an extended hamming code may be used. The required number of bits in that case is as follows:

| Number of bits | | Extended |
|---|---|---|
| of word | Hamming code | hamming code |
| 4 bits | 3 bits | 4 bits |
| 8 bits | 4 bits | 5 bits |
| 16 bits | 5 bits | 6 bits |
| 32 bits | 6 bits | 7 bits |
| 64 bits | 7 bits | 8 bits |

Further, in the present embodiment, as an ECC code, a code enabling multiple bit correction (for example, BCH code) or a code enabling block correction (for example, Read-Solomon code) may be used.

Next, operation of the present embodiment will be described.

When words are serially input to the code word generation section 111 of the signal transmission circuit 110 from the outside, the code word generation section 111 generates code words in each of which an ECC code is added to an input word, and outputs them to the conversion section 112. The conversion section 112 divides the code words generated by the conversion section 112 into bit strings each including information bits having the same number of bits as that of the word and code bits having the same number of bits as that of the ECC code, and outputs them to the signal line group 130 in units of bit strings. In this step, the conversion section 112 outputs the information bits of a bit string to the signal line group 131, and outputs the code bits of the bit string to the signal line group 132. When dividing code words into bit strings, the conversion section 112 divides them in such a manner as to satisfy a condition that a plurality of bits of the same code word (preferably, any 2 bits of the same code word) are not output at the same time within the range of the signal line group 130 or within the range of a partial signal line group constituting the signal line group 130, and that the respective bits of the ECC code of the same code word are output to different signal lines of the signal line group 132, respectively.

On the other hand, the inversion section 121 of the signal reception circuit 120 reorders the bit strings received from the signal line group 130 to reproduce the original code words, and outputs them to the error correction section 122. The error correction section 122 performs error correction of each of the words with use of the ECC code included in the code word reproduced by the inversion section 121, and outputs the word to the outside in the word unit.

As described above, according to the signal transmission/reception circuit 100 of the present embodiment, it is possible to ensure error correction capability with respect to both simultaneous switching errors and multiple errors which occur on a particular signal line. This is because as a plurality of bits of the same code word are not output at the same time on a particular signal line group of the signal line group 130, that is, on a plurality of signal lines in which the drive circuits driving the signal lines use the same power source, even if simultaneous switching errors occur, the probability that errors occur in a plurality of bits of the same code word can be reduced. Further, as the respective bits of the ECC code of the same code word are not output to the same signal line, even if multiple errors occur on a particular signal line, the probability that errors occur in a plurality of bits of the ECC code of the same code word can be reduced.

### Second Exemplary Embodiment

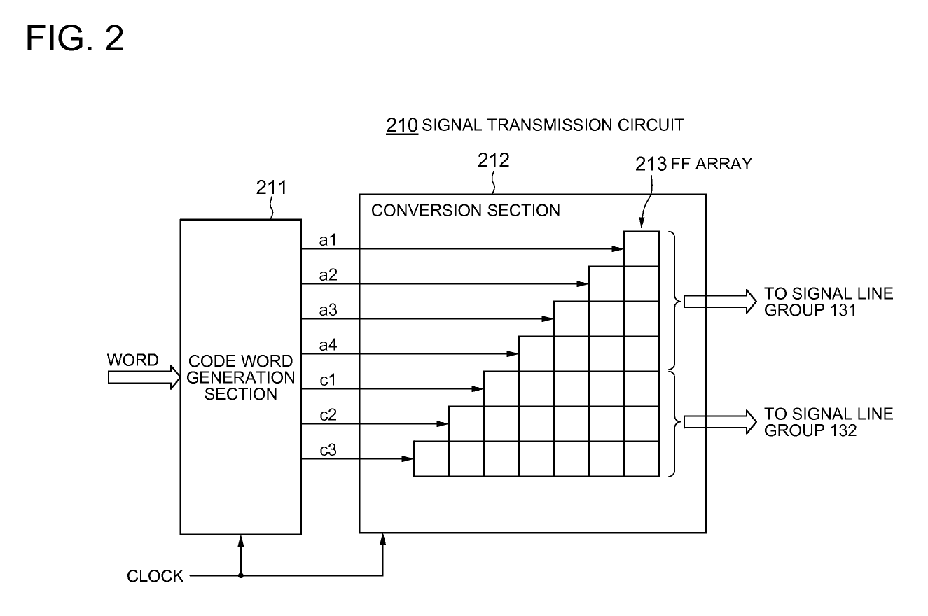

Referring to FIG. 2, a signal transmission circuit 210 according to a second exemplary embodiment of the present invention includes a code word generation section 211 and a conversion section 212. Hereinafter, the configuration of each of the sections will be described using, as an example, a hamming code in which the number of bits of a word is 4 bits and the number of bits of an ECC code is 3 bits.

The code word generation section 211 inputs 4 bits constituting a word in synchronization with the clock, generates a 3-bit ECC code from the 4 bits by means of a well-known method, and outputs, to the conversion section 212, a code word constituted of a total of 7 bits including the 4 bits a1, a2, a3, and a4 constituting the input word and the 3 bits c1, c2, and c3 constituting the generated ECC code.

The conversion section 212 includes an FF array 213 having a plurality of cells. Each cell is formed of one flip flop. Hereinafter, it is defined that the horizontal direction of a sheet is a row, the vertical direction thereof is a column, and a cell in the i^{th} row and the j^{th} column is expressed as C_{i,j}. The FF array 213 is configured such that one cell C_{1,1} is arrayed in the 1^{st} row, 2 cells C_{2,1} and C_{2,2} are arrayed in the 2^{nd} row, the number of cells is incremented by 1 in each of the following rows, and 7 cells C_{7,1}, C_{7,2}, C_{7,3}, C_{7,4}, C_{7,5}, C_{7,6} and C_{7,7} are arrayed in the 7^{th} row which is the last row. The conversion section 212 receives respective bits of code words in synchronization with the clock. The respective bits of each code word, input to the conversion section 212, are input to the cells C_{1,1}, C_{2,1}, C_{3,1}, C_{4,1}, C_{5,1}, C_{6,1}, and C_{7,1} in the first column of the respective rows of the FF array 213. In this step, the bit information stored in each cell is moved to a cell in the next column, and the pieces of bit information stored in the cells C_{1,1}, C_{2,2}, C_{3,3}, C_{4,4}, C_{5,5}, C_{6,6}, and C_{7,7} in the last column are output to the signal line groups 131 and 132. This means that the respective rows of the FF array 213 constitute shift registers having the different number of stages, respectively.

Next, operation of the signal transmission circuit 210 according to the present embodiment will be described.

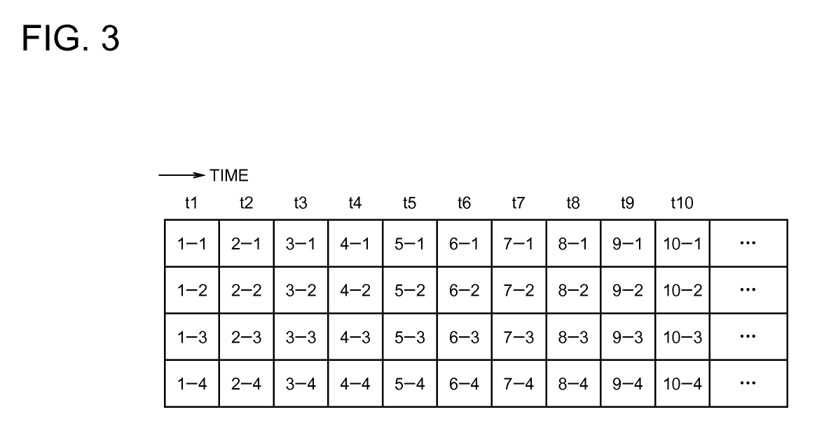

FIG. 3 shows a time series of words input to the signal transmission circuit 210. In FIG. 3, the vertical direction shows the sequence of the bits in a word, and the horizontal direction shows the time. In order to discriminate a word from another word, and to discriminate the bits in a word from other bits, a reference code in the form of “word identifier—intra-word identifier” is given to each bit of a word. For example, a bit 7-1 input at a time t7 shows the 1^{st} bit of the 7^{th} input word.

The code word generation section 211 of the signal transmission circuit 210 inputs the words, input in the order as shown in FIG. 3, in synchronization with the clock, and for each of the words, generates a 3-bit ECC code for correcting errors of the 4 bits constituting the word, and outputs a code word having a total of 7 bits to the conversion section 212.

The conversion section 212 serially inputs the 7 bits of the code word, output from the code word generation section 211, to the FF array 213 in synchronization with the clock. Further, the conversion section 212 outputs a bit string, output from the FF array 213, to the signal line groups 131 and 132. In this step, the 4 bits output from the 1^{st} to 4^{th} rows of the FF array 213 (the respective bits are bits of different words) are output to the signal line 131, and the 3 bits output from the 5^{th} to 7^{th} rows (the respective bits are ECC code bits of different code words) are output to the signal line 132.

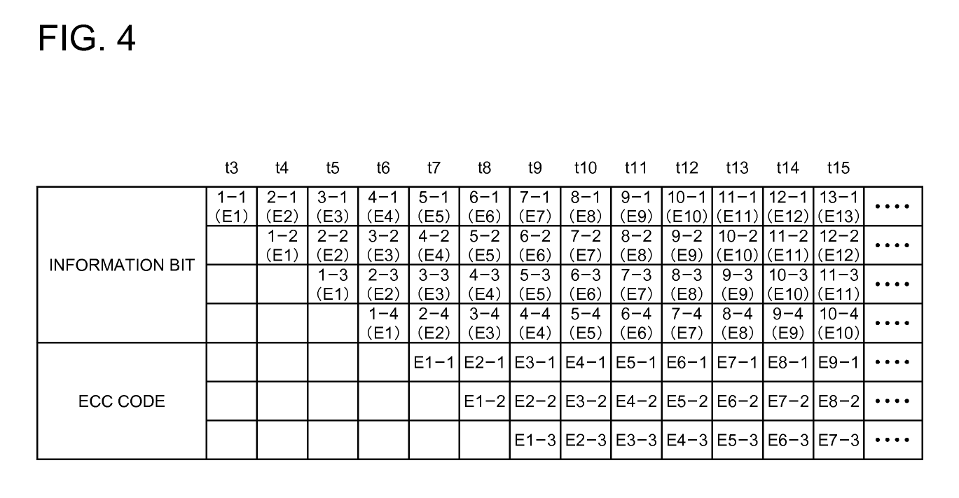

FIG. 4 shows a time series of bit strings output from the conversion section 212 to the signal line groups. In FIG. 4, the vertical direction shows the sequence of bits in a bit string, and the horizontal direction shows the time. In order to distinguish an ECC code from ECC codes of other code words, and to distinguish the bits in the ECC code of the same code word from other bits, a reference code in the form of “code word identifier—intra-ECC code identifier” is given to each bit of an ECC code. For example, a bit E5-1 output at a time t11 shows that it is the 1^{st} bit in the ECC code of the 5^{th} code word. Further, in order to clarify a code word to which each bit of each word belongs, a code word identifier is given in parentheses to a bit of a word. For example, a bit 7-3(E7), which is the 3^{rd} bit in the 7^{th} word, shows that it belongs to the 7^{th} code word.

Referring to FIG. 4, in the present embodiment, the bits constituting a code word are arranged in two dimensions with respect to the parallel transmission direction of the signal line group and the time direction, and the bits output at the same time and the bits output to the same signal line are mere 1 bit per code word. Accordingly, even if errors occur in all of the bits on a signal line group due to simultaneous switching noise, as the respective bits belong to different code words respectively, the errors can be corrected. For example, if errors occur in all of the bits 7-1, 6-2, 5-3, and 4-4 transmitted at a time t9, as the bit 7-1 belongs to the 7^{th} code word, the bit 6-2 belongs to the 6^{th} code word, the bit 5-3 belongs to the 5^{th} code word, and the bit 4-4 belongs to the 4^{th} code word, respectively, when error correction of 1 bit is performed on each code word, it is possible to perform error correction on all of the bits constituted of the bits 7-1, 6-2, 5-3, and 4-4, consequently. Further, even if multiple errors occur in any one of the signal lines, as the respective bits belong to different code words respectively, the errors can be corrected. As such, in the present embodiment, it is possible to ensure error correction capability with respect to both simultaneous switching errors and multiple errors which occur on a particular signal line.

It should be noted that in the present embodiment, as the parallelism of transmission is degraded substantially in the first 6 clocks after the start of communication and the last 6 clocks, the present embodiment is suitable for a device in which word signals flow constantly and continuously.

### Third Exemplary Embodiment

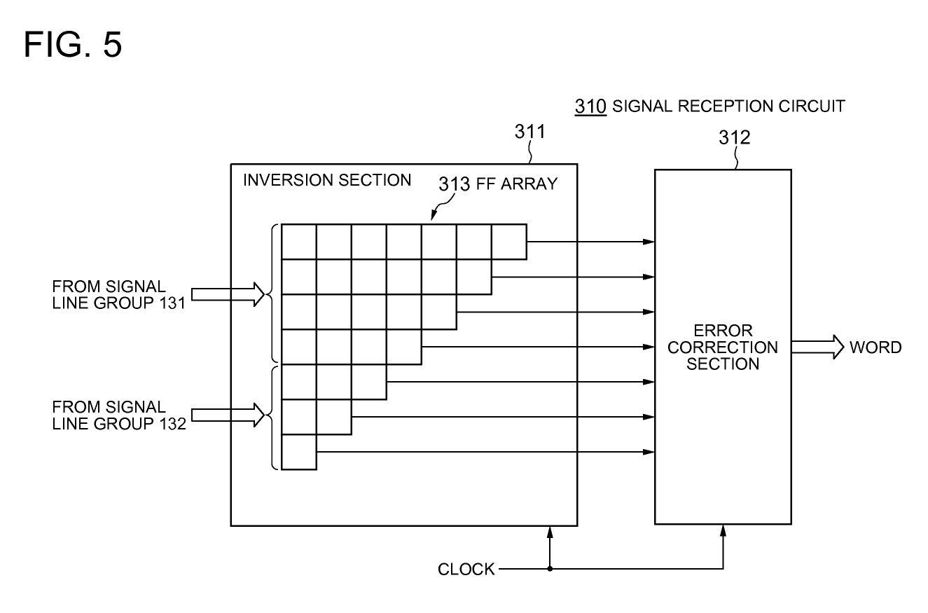

Referring to FIG. 5, a signal reception circuit 310 according to a third exemplary embodiment of the present invention includes an inversion section 311 and an error correction section 312. Hereinafter, the configuration of each of the sections will be described using, as an example, a hamming code in which the number of bits of a word is 4 bits and the number of bits of an ECC code is 3 bits.

The inversion section 311 includes an FF array 313 having a plurality of cells. Each cell is formed of one flip flop. The FF array 313 is configured such that 7 cells C_{1,1}, C_{1,2}, C_{1,3}, C_{1,4}, C_{1,5}, C_{1,6} and C_{1,7} are arrayed in the 1^{st} row, 6 cells C_{2,1}, C_{2,2}, C_{2,3}, C_{2,4}, C_{2,5}, and C_{2,6} are arrayed in the 2^{nd} row, the number of cells is decremented by 1 in each of the following rows, and one cell C_{1,1} is arrayed in the 7^{th} row which is the last row. The inversion section 311 receives respective bits of code words in synchronization with the clock. The respective bits of the code words, input to the inversion section 311, are input to the cells C_{1,1}, C_{2,1}, C_{3,1}, C_{4,1}, C_{5,1}, C_{6,1}, and C_{7,1} in the first column of the respective rows of the FF array 313. In this step, the bit information stored in each cell is moved to a cell in the next column, and the pieces of bit information stored in the cells C_{1,7}, C_{2,6}, C_{3,5}, C_{4,4}, C_{5,3}, C_{6,2}, and C_{7,1} in the last column are output to the error correction section 312 as one code word. This means that the respective rows of the FF array 313 constitute shift registers having the different number of stages, respectively.

The error correction section 312 performs error correction of a word using an ECC code included in a code word reproduced by the inversion section 311, and outputs the word to the outside in the word unit. Specifically, the error correction section 312 performs well-known calculation using a total of 7 bits, including the information bits and the ECC code of the input code word, to obtain a 3-bit syndrome, determines presence or absence of an error from the 3-bit syndrome, and if there is an error in any 1 bit of the 4-bit information bits, performs error correction using the 3-bit syndrome.

Next, operation of the signal reception circuit 310 according to the present embodiment will be described.

To the signal reception circuit 310, time series signals as shown in FIG. 4 are input via the signal line group 130. The inversion section 311 of the signal reception circuit 310 serially inputs the bit strings, input in the order as shown in FIG. 4, to the FF array 313 in synchronization with the clock, and outputs 7 bits, output from the FF array 313, to the error correction section 312. For example, when a bit string 8-1, 7-2, 6-3, 5-4, E4-1, E3-2, and E2-3 at a time t10 in FIG. 4 is input to the FF array 313, a bit string 1-1, 1-2, 1-3, 1-4, E1-1, E1-2, and E1-3, that is, the first code word constituted of the first word and the ECC code thereof, is output from the last cells C_{1,7}, C_{2,6}, C_{3,5}, C_{4,4}, C_{5,3}, C_{6,2}, and C_{7,1} of the FF array 313, to the error correction section 312.

Each time a new code word is input, the error correction section 312 performs error checking of the code word. Then, if detecting an error of 1 bit, the error correction section 312 corrects the error, and outputs the word in which the error has been corrected.

According to the present embodiment, it is possible to provide a signal reception circuit which can be used in combination with the signal transmission circuit of the second exemplary embodiment.

### Fourth Exemplary Embodiment

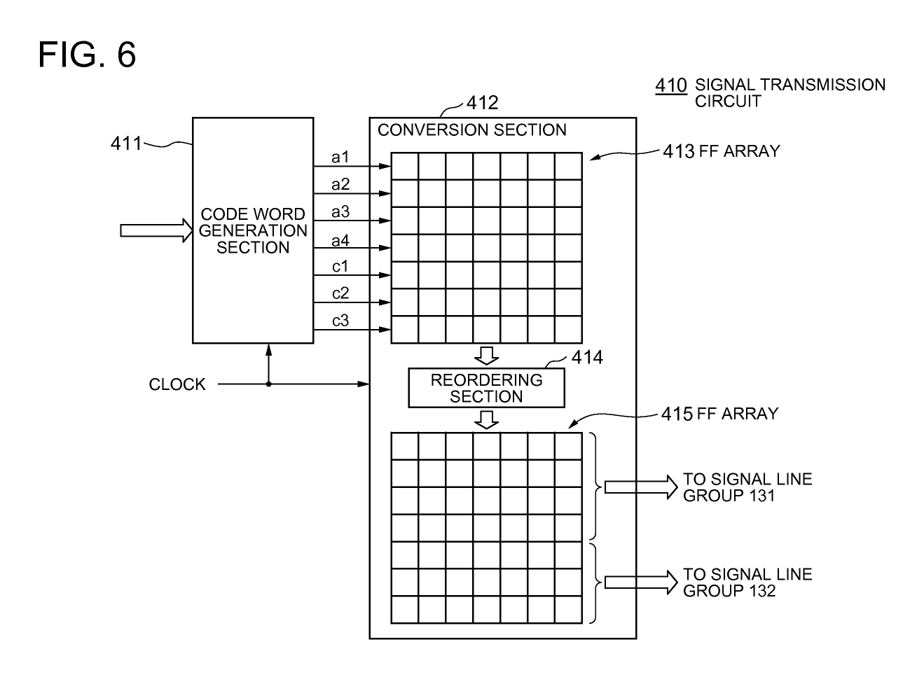

Referring to FIG. 6, a signal transmission circuit 410 according to a fourth exemplary embodiment of the present invention includes a code word generation section 411 and a conversion section 412. Hereinafter, the configuration of each of the sections will be described using, as an example, a hamming code in which the number of bits of a word is 4 bits and the number of bits of an ECC code is 3 bits.

The code word generation section 411 receives 4 bits constituting a word in synchronization with the clock, generates a 3-bit ECC code from the 4 bits, and outputs, to the conversion section 412, a code word constituted of a total of 7 bits including the 4 bits a1, a2, a3, and a4 constituting the input word and the 3 bits c1, c2, and c3 constituting the generated ECC code.

The conversion section 412 includes an FF array 413, a reordering section 414, and an FF array 415.

The FF array 413 includes 7 (=code word length)×7 (=code word length) cells. Each cell is formed of one flip flop. The conversion section 412 receives respective bits constituting code words from the code word generation section 411 in synchronization with the clock. The respective bits of each code word, input to the conversion section 412, are input to the cells C_{1,1}, C_{2,1}, C_{3,1}, C_{4,1}, C_{5,1}, C_{6,1}, and C_{7,1} in the first column of the FF array 413. In this step, the bit information stored in each cell is moved to a cell in the next column, and the pieces of bit information stored in the cells C_{1,7}, C_{2,7}, C_{3,7}, C_{4,7}, C_{5,7}, C_{6,7}, and C_{7,7} in the last column are discarded. As such, each row of the FF array 413 constitutes a shift register. Further, the pieces of bit information stored in the cells of the FF array 413 can be read in parallel. In the present embodiment, every 7 clocks, a total of 49 (=code word length×code word length) bits are read from the entire cells by the reordering section 414.

The FF array 415 includes 7 (=code word length)×7 (=code word length) cells. Each cell is formed of one flip flop. To the cells of the FF array 415, bit information can be written in parallel. The pieces of bit information written in the respective cells of the FF array 415 may be shifted in the row direction. When the FF array 415 is shifted by one to the right, the pieces of bit information stored in the respective columns are moved to the cells in the next column, the information bits stored in the cells C_{1,7}, C_{2,7}, C_{3,7}, and C_{4,7} in the last column are output to the signal line 131, and the code bits stored in the cells C_{5,7}, C_{6,7}, and C_{7,7} in the last column are output to the signal line 132.

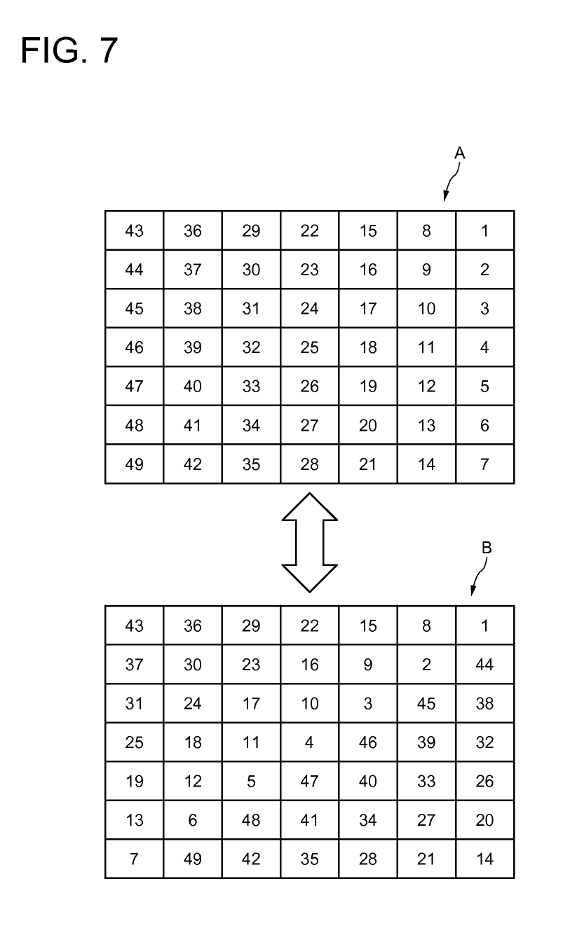

The reordering section 414 reorders the 49 bits of the 7 code words read from the FF array 413, and stores them in the FF array 415. When reordering, the reordering section 414 reorders the bits in such a manner that a combination of any 2 bits of the same code word on the FF array 413 are neither a combination of bits to be stored in cells in the same row of the FF array 415 nor a combination of bits to be stored in cells in the same column of the FF array 415. Specifically, in the present embodiment, the reordering section 414 reorders the bits from an array A to an array B as shown in FIG. 7. As such, the bit stored in the cell C_{2,7} of the FF array 413 is moved to the cell C_{2,6} of the FF array 415, and the bit stored in the cell C_{3,7} of the FF array 413 is moved to the cell C_{3,5} of the FF array 415, for example. In this way, the reordering is performed one by one. Accordingly, by connecting the parallel output terminal of each cell of the FF array 413 with the parallel input terminal of the corresponding cell of the FF array 415 by wiring, desired reordering can be performed.

Next, operation of the signal transmission circuit 410 according to the present embodiment will be described.

To the signal transmission circuit 410, time series signals as shown in FIG. 3 are input. The code word generation section 411 of the signal transmission circuit 410 serially receives the words, input in the order as shown in FIG. 3, in synchronization with the clock, generates a 3-bit ECC code for correcting errors of the 4 bits constituting a word, and outputs a code word having a total of 7 bits to the conversion section 412.

The conversion section 412 inputs code words, output from the code word generation section 411, to the FF array 413 in synchronization with the clock. Then, when 7 pieces of continuous code words are input to the FF array 413, a total of 49 bits, read from the FF array 413, are reordered by the reordering section 414, and are stored in the FF array 415. Then, the conversion section 412 applies a right shift to the FF array 415 in synchronization with the clock. Thereby, a bit string, output from the FF array 415, is output to the signal lines 131 and 132.

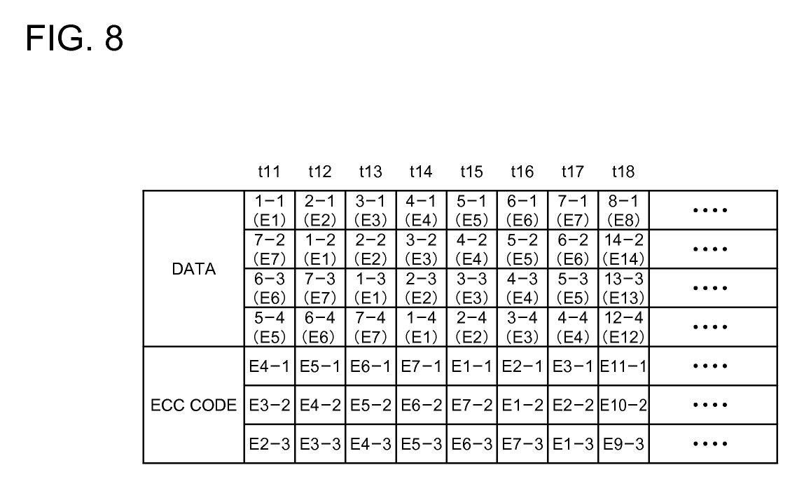

FIG. 8 is a time series of bit strings output from the FF array 415 to the signal line groups. As shown in FIG. 8, in the present embodiment, the bits constituting code words are two-dimensionally arranged with respect to the parallel transmission direction and the time direction of the signal line group, and the bits output at the same time and the bits output to the same signal line are mere 1 bit per code word. Accordingly, it is possible to ensure error correction capability with respect to both simultaneous switching errors and multiple errors on a particular signal line.

Further, in the present embodiment, the information bits of 7 words and the entire bits of the ECC codes for those words can be transmitted in the unit of 7×7 bits. As such, the present embodiment is particularly suitable for transmission of burst data.

### Fifth Exemplary Embodiment

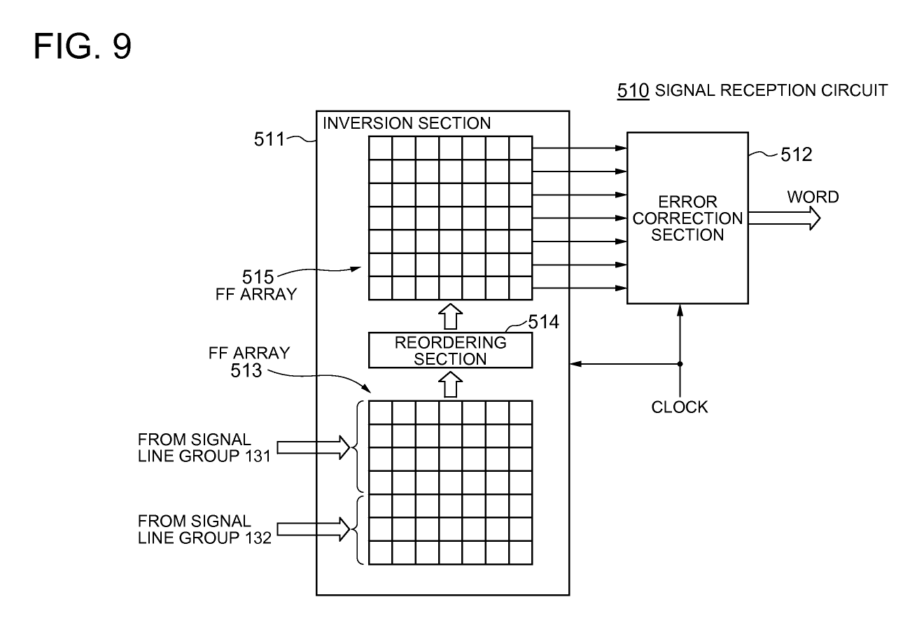

Referring to FIG. 9, a signal reception circuit 510 according to a fifth exemplary embodiment of the present invention includes an inversion section 511 and an error correction section 512. Hereinafter, the configuration of each of the sections will be described using, as an example, a hamming code in which the number of bits of a word is 4 bits and the number of bits of an ECC code is 3 bits.

The inversion section 511 includes an FF array 513, a reordering section 514, and an FF array 515.

The FF array 513 includes 7 (=code word length)×7 (=code word length) pieces of cells. Each cell is formed of one flip flop. The inversion section 511 receives respective bits, constituting code words, from the signal line groups 131 and 132 in synchronization with the clock. The respective bits of the code words, input to the inversion section 511, are input to the cells C_{1,1}, C_{2,1}, C_{3,1}, C_{4,1}, C_{5,1}, C_{6,1}, and C_{7,1} in the first column of the respective rows of the FF array 513. In this step, the bit information stored in each cell is moved to a cell in the next column, and the pieces of bit information stored in the cells C_{1,7}, C_{2,7}, C_{3,7}, C_{4,7}, C_{5,7}, C_{6,7}, and C_{7,7} in the last column are discarded. As such, each row of the FF array 513 constitutes a shift register. Further, the pieces of bit information stored in the cells of the FF array 513 can be read in parallel. In the present embodiment, every 7 clocks, a total of 49 (=code word length×code word length) bits are read from the entire cells by the reordering section 514.

The FF array 515 includes 7 (=code word length)×7 (=code word length) pieces of cells. Each cell is formed of one flip flop. To the cells of the FF array 515, bit information can be written in parallel. The pieces of bit information written in the respective cells of the FF array 515 may be shifted in the row direction. When the FF array 515 is shifted by one to the right, the pieces of bit information stored in the respective columns are moved to the cells in the next column, and a total of 7 bits stored in the cells C_{1,7}, C_{2,7}, C_{3,7}, C_{4,7}, C_{5,7}, C_{6,7}, and C_{7,7}, in the last column are output to the error correction section 512 as one code word.

The reordering section 514 reorders the 49 bits read from the FF array 513, and stores them in the FF array 515. When reordering, the reordering section 514 reorders the bits in such a manner that the bits of the same code word on the FF array 513 are stored in cells in the same column of the FF array 515. Specifically, in the present embodiment, the reordering section 514 reorders the bits from the array B to the array A as shown in FIG. 7. As such, the bit stored in the cell C_{2,6} of the FF array 513 is moved to the cell C_{2,7} of the FF array 515, for example. Further, the bit stored in the cell C_{3,5} of the FF array 513 is moved to the cell C_{3,7} of the FF array 515. In this way, reordering is performed one by one. Accordingly, by connecting the parallel output terminal of each cell of the FF array 513 with the parallel input terminal of the corresponding cell of the FF array 515 by wiring, desired reordering can be performed.

The error correction section 512 performs error correction of a word using the ECC code included in the code word reproduced by the inversion section 511, and outputs the word to the outside in the word unit.

Next, operation of the signal reception circuit 510 according to the present embodiment will be described.

To the signal reception circuit 510, time series signals as shown in FIG. 8 are input via the signal line groups 131 and 132. The inversion section 511 of the signal reception circuit 510 serially inputs the bit strings, input in the order as shown in FIG. 8, to the FF array 513 in synchronization with the clock. Then, when 7 pieces of continuous bit strings are input to the FF array 513, a total of 49 bits, read from the FF array 513, are reordered by the reordering section 514, and are stored in the FF array 515. Then, the inversion section 511 applies a right shift to the FF array 515 in synchronization with the clock. Thereby, a bit string, output from the FF array 515, is output to the error correction section 512 as one code word. For example, 49 bits from a time t11 to a time t17 in FIG. 8 are stored in the FF array 513 and then reordered and moved to the FF array 515, and when a right shift is applied to the FF array 515, a bit string 1-1, 1-2, 1-3, 1-4, E1-1, E1-2, and E1-3, that is, the first code word constituted of the first word and the ECC code thereof, is output from the cells C_{1,7}, C_{2,6}, C_{3,5}, C_{4,4}, C_{5,3}, C_{6,2}, and C_{7,1} in the last column of the FF array 515 to the error correction section 512.

Each time a new code word is input, the error correction section 512 performs error checking of the code word. Then, if detecting an error of 1 bit, the error correction section 512 corrects the error, and outputs the word in which the error has been corrected.

According to the present embodiment, it is possible to provide a signal reception circuit which can be used in combination with the signal transmission circuit of the fourth exemplary embodiment.

### Sixth Exemplary Embodiment

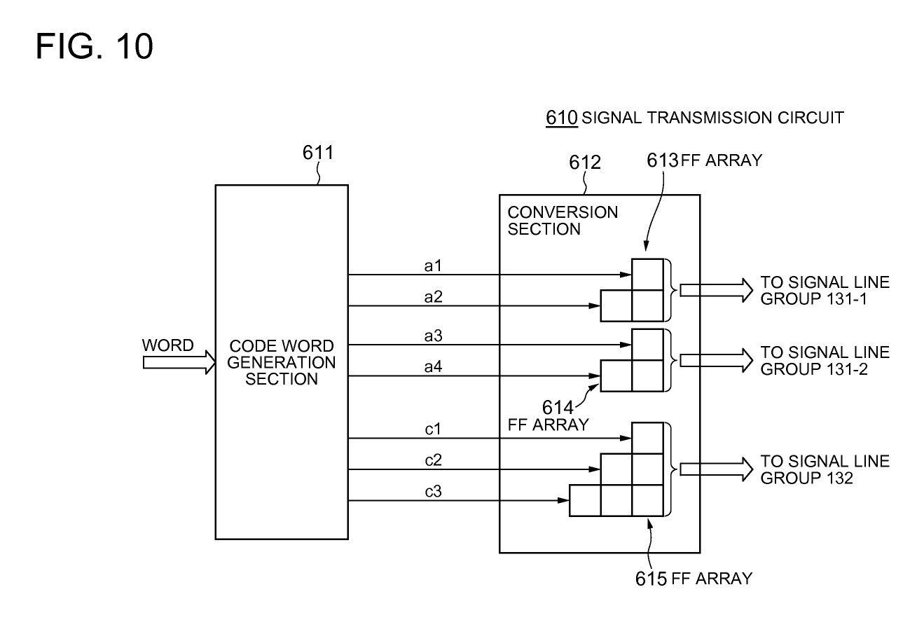

Referring to FIG. 10, a signal transmission circuit 610 according to a sixth exemplary embodiment of the present invention includes a code word generation section 611 and a conversion section 612. Hereinafter, the configuration of each of the sections will be described using, as an example, a hamming code in which the number of bits of a word is 4 bits and the number of bits of an ECC code is 3 bits. Further, the signal line group 131 connected with the signal transmission circuit 610 is divided into a signal line group 131-1 belonging to a power bank A and a signal line group 131-2 belonging to a power bank B. Further, the signal line group 132 belongs to another power bank C.

The code word generation section 611 receives 4 bits constituting a word in synchronization with the clock, generates a 3-bit ECC code from the 4 bits by means of a well-known method, and outputs, to the conversion section 612, a code word constituted of a total of 7 bits including the 4 bits a1, a2, a3, and a4 constituting the input word and the 3 bits c1, c2, and c3 constituting the generated ECC code.

The conversion section 612 includes an FF array 613 associated with the signal line group 131-1, an FF array 614 associated with the signal line group 131-2, and an FF array 615 associated with the signal line group 132.

Each of the FF arrays 613 to 615 includes a plurality of cells. Each cell is formed of one flip flop. Each of the FF arrays 613 and 614 is configured such that one cell C_{1,1} is arrayed in the 1^{st} row and 2 cells C_{2,1} and C_{2,2} are arrayed in the 2^{nd} row. The FF array 615 is configured such that one cell C_{1,1} is arrayed in the 1^{st} row, 2 cells C_{2,1} and C_{2,2} are arrayed in the 2^{nd} row, and 3 cells C_{3,1}, C_{3,2} and C_{3,3} are arrayed in the 3^{rd} row. The conversion section 612 receives respective bits of code words in synchronization with the clock. The respective bits of each code word, input to the conversion section 612, are input to the cells in the first columns of the respective rows of the FF arrays 613 to 615. In this step, the bit information stored in each cell is moved to a cell in the next column, and the pieces of bit information stored in the cells in the last columns are output to the signal line groups 131-1, 131-2, and 132. This means that the respective rows of the FF arrays 613 to 615 constitute shift registers having the different number of stages, respectively.

Next, operation of the signal transmission circuit 610 according to the present embodiment will be described.

The code word generation section 611 of the signal transmission circuit 610 receives the words input in the order as shown in FIG. 3 in synchronization with the clock, generates a 3-bit ECC code for correcting errors of the 4 bits constituting a word, and outputs a code word having a total of 7 bits to the conversion section 612.

The conversion section 612 serially inputs the 7 bits of the code word, output from the code word generation section 611, to the FF arrays 613 to 615 in synchronization with the clock. Further, the conversion section 612 outputs a bit string, output from the FF arrays 613 to 615, to the signal line groups 131-1, 131-2, and 132. In this step, 2 bits output from the 1^{st} and 2^{nd} rows of the FF array 613 (the respective bits are bits of different words) are output to the signal line group 131-1, 2 bits output from the 1^{st} and 2^{nd} rows of the FF array 614 (the respective bits are bits of different words) are output to the signal line group 131-2, and 3 bits output from the 1^{st} to 3^{rd} rows of the FF array 615 (the respective bits are ECC code bits of different code words) are output to the signal line group 132.

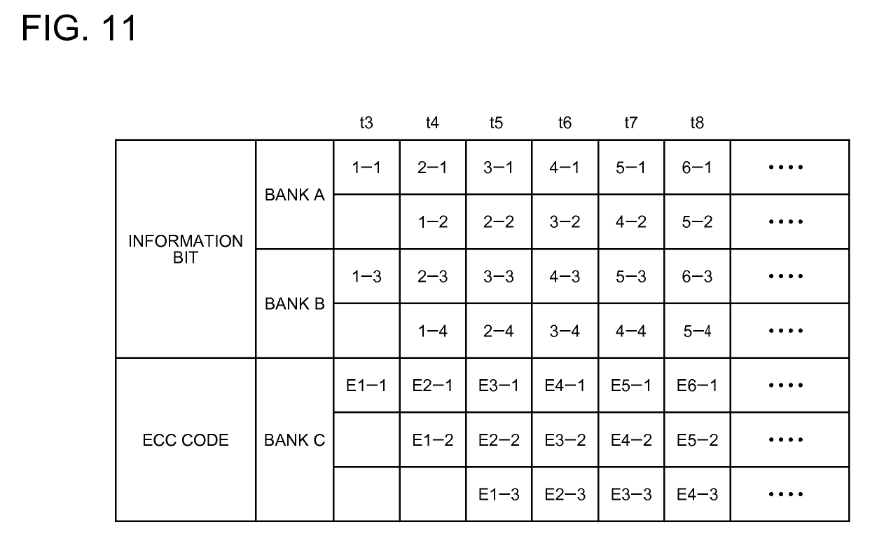

FIG. 11 is a time series of bit strings output from the FF array 612 to the signal line groups. As shown in FIG. 11, in the present embodiment, the bits constituting a code word are two-dimensionally arranged with respect to the parallel transmission direction of the signal line group and the time direction by each power bank, and the bits output at the same time and the bits output to the same signal line are mere 1 bit per code word. Accordingly, it is possible to ensure error correction capability with respect to both simultaneous switching errors and multiple errors on a particular signal line.

It should be noted that in the present embodiment, as the parallelism of transmission is degraded substantially in the first 2 clocks after the start of communication and the last 2 clocks, the present embodiment is suitable for a device in which word signals flow constantly and continuously.

### Seventh Exemplary Embodiment

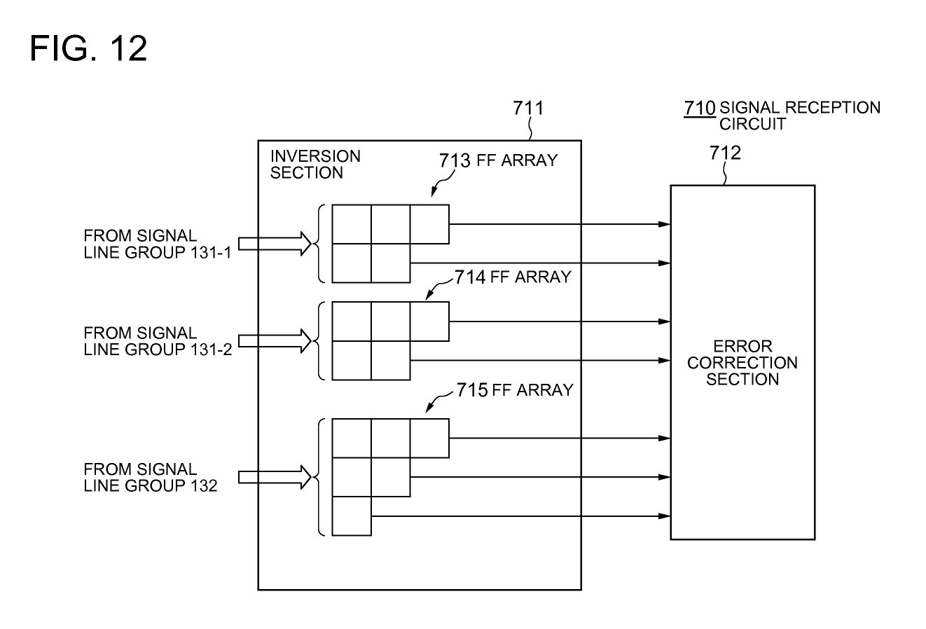

Referring to FIG. 12, a signal reception circuit 710 according to a seventh exemplary embodiment of the present invention includes an inversion section 711 and an error correction section 712. Hereinafter, the configuration of each of the sections will be described using, as an example, a hamming code in which the number of bits of a word is 4 bits and the number of bits of an ECC code is 3 bits. Further, the signal line group 131 connected with the signal reception circuit 710 is divided into a signal line group 131-1 belonging to a power bank A and a signal line group 131-2 belonging to a power bank B. Further, the signal line group 132 belongs to another power bank C.

The inversion section 711 includes an FF array 713 associated with the signal line group 131-1, an FF array 714 associated with the signal line group 131-2, and an FF array 715 associated with the signal line group 132.

Each of the FF arrays 713 to 715 includes a plurality of cells. Each cell is formed of one flip flop. Each of the FF arrays 713 and 714 is configured such that 3 cells C_{3,1}, C_{3,2} and C_{3,3} are arrayed in the 1^{st} row and 2 cells C_{2,1} and C_{2,2} are arrayed in the 2^{nd} row. The FF array 715 is configured such that 3 cells C_{3,1}, C_{3,2} and C_{3,3} are arrayed in the 1^{st} row, 2 cells C_{2,1} and C_{2,2} are arrayed in the 2^{nd} row, and one cell C_{1,1} is arrayed in the 3^{rd} row. The inversion section 711 receives respective bits of code words from the signal line groups 131-1, 131-2, and 132 in synchronization with the clock. The respective bits of each code word, input to the inversion section 711, are input to the cells in the 1^{st} columns of the respective rows of the FF arrays 713 to 715. In this step, the bit information stored in each cell is moved to a cell in the next column, and the pieces of bit information stored in the cells in the last columns are output to the error correction section 712 as one code word. This means that the respective rows of the FF arrays 713 to 715 constitute shift registers having the different number of stages, respectively.

The error correction section 712 performs error correction of the word using the ECC code included in the code word input from the inversion section 711, and outputs the word to the outside in the word unit. Specifically, the error correction section 712 performs well-known calculation using a total of 7 bits including the information bits and the ECC code of the input code word to obtain a 3-bit syndrome, determines presence or absence of an error from the 3-bit syndrome, and if there is an error in any 1 bit of the 4-bit information bits, performs error correction using the 3-bit syndrome.

Next, operation of the signal reception circuit 710 according to the present embodiment will be described.

To the signal reception circuit 710, time series signals as shown in FIG. 11 are input via the signal line groups 131-1, 131-2, and 132. The inversion section 711 of the signal reception circuit 710 serially inputs the bit strings, input in the order as shown in FIG. 11, to the FF arrays 713 to 715 in synchronization with the clock, and outputs 7 bits, output from the FF arrays 713 to 715, to the error correction section 712. For example, when a bit string 4-1, 3-2, 4-3, 3-4, E4-1, E3-2, and E2-3 at a time t6 in FIG. 11 is input to the FF arrays 713 to 715, a bit string 1-1, 1-2, 1-3, 1-4, E1-1, E1-2, and E1-3, that is, the first code word constituted of the first word and the ECC code thereof, is output from the last cells of the FF arrays 713 to 715, to the error correction section 712.

Each time a new code word is input, the error correction section 712 performs error checking of the code word. Then, if detecting an error of 1 bit, the error correction section 712 corrects the error, and outputs the word in which the error has been corrected.

According to the present embodiment, it is possible to provide a signal reception circuit which can be used in combination with the signal transmission circuit of the sixth exemplary embodiment.

### Eighth Exemplary Embodiment

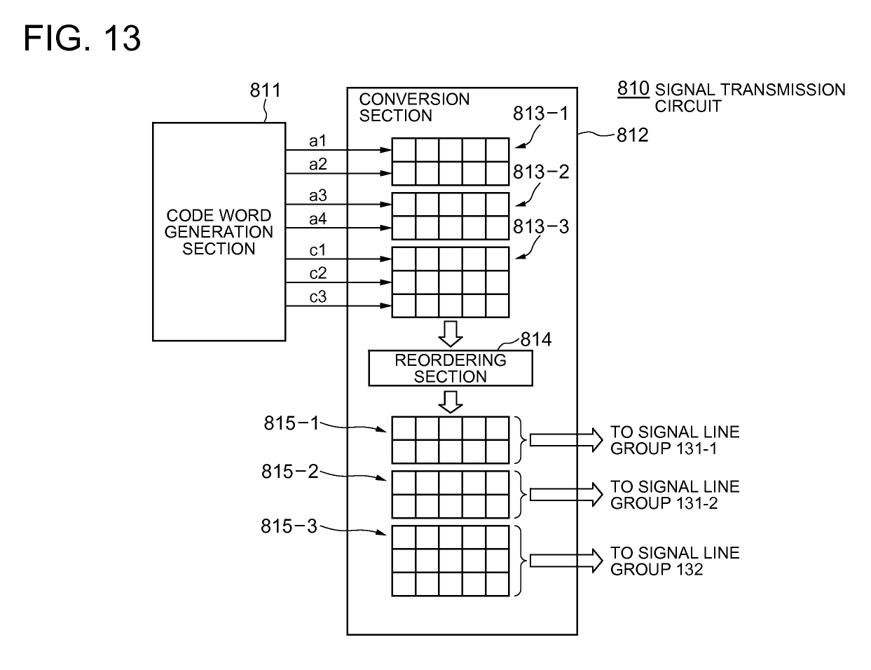

Referring to FIG. 13, a signal transmission circuit 810 according to an eighth exemplary embodiment of the present invention includes a code word generation section 811 and a conversion section 812. Hereinafter, the configuration of each of the sections will be described using, as an example, a hamming code in which the number of bits of a word is 4 bits and the number of bits of an ECC code is 3 bits. Further, the signal line group 131 connected with the signal transmission circuit 810 is divided into a signal line group 131-1 belonging to a power bank A and a signal line group 131-2 belonging to a power bank B. Further, the signal line group 132 belongs to another power bank C.

The code word generation section 811 receives 4 bits constituting a word in synchronization with the clock, generates a 3-bit ECC code from the 4 bits, and outputs, to the conversion section 812, a code word constituted of a total of 7 bits including the 4 bits a1, a2, a3, and a4 constituting the input word and the 3 bits c1, c2, and c3 constituting the generated ECC code.

The conversion section 812 includes an FF array 813, a reordering section 814, and an FF array 815.

The FF array 813 is formed of three FF arrays 813-1 to 813-3. Each of the FF arrays 813-1 to 813-3 includes a plurality of cells. Each cell is formed of one flip flop. Each of the FF arrays 813-1 and 813-2 includes 2×5 cells. The FF array 813-3 includes 3×5 cells. The conversion section 812 receives respective bits constituting code words in synchronization with the clock. The respective bits of each code word, input to the conversion section 812, are input to the cells in the first columns of the respective rows of the FF arrays 813-1 to 813-3. In this step, the bit information stored in each cell is moved to a cell in the next column, and the pieces of bit information stored in the cells in the last columns are discarded. As such, each row of the FF arrays 813-1 to 813-3 constitutes a shift register. Further, the pieces of bit information stored in the cells of the FF arrays 813-1 to 813-3 can be read in parallel. In the present embodiment, every 5 clocks, a total of 35 bits are read from the entire cells of the FF arrays 813-1 to 813-3 by the reordering section 814.

The FF array 815 is formed of three FF arrays 815-1 to 815-3. Each of the FF arrays 815-1 to 815-3 includes a plurality of cells. Each cell is formed of one flip flop. The FF arrays 815-1 is associated with the signal line group 131-1, and includes 2×5 cells. The FF arrays 815-2 is associated with the signal line group 131-2, and includes 2×5 cells. The FF array 815-3 is associated with the signal line group 132, and includes 3×5 cells. To the cells of each of the FF arrays 815-1 to 815-3, bit information can be written in parallel. The pieces of bit information written in the respective cells of the FF arrays 815-1 to 815-3 may be shifted in the row direction. When each of the FF arrays 815-1 to 815-3 is shifted by one to the right, the pieces of bit information stored in the respective columns are moved to the cells in the next column, and the information bits stored in the cells in the last columns are output to the signal line groups 131-1, 131-2, and 132.

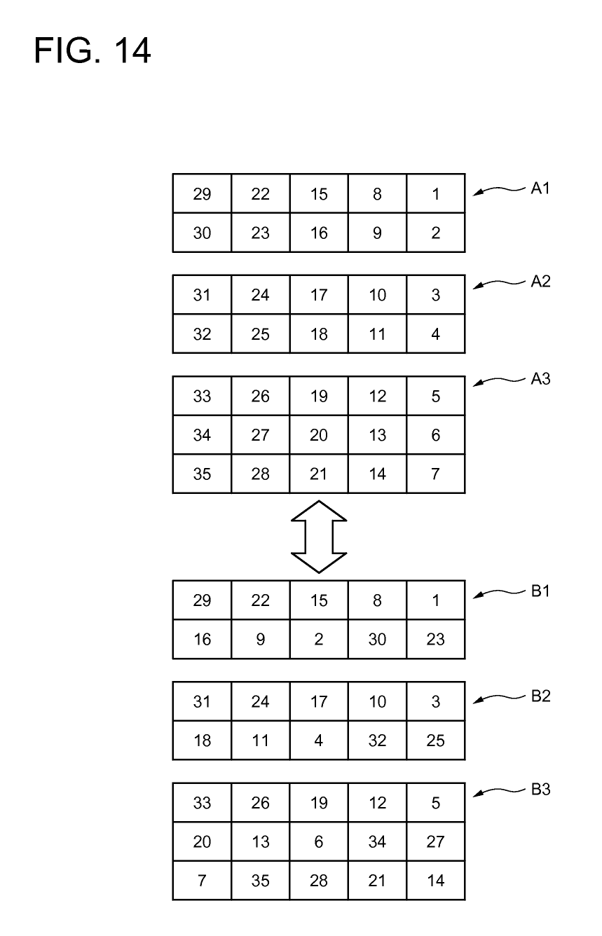

For each of a set of the FF array 813-1 and the FF array 815-1, a set of the FF array 813-2 and the FF array 815-2, and a set of the FF array 813-3 and the FF array 815-3, the reordering section 814 reorders the bits read from the FF array 813, and stores them in the FF array 815. When reordering, the reordering section 814 reorders the bits in such a manner that a combination of any 2 bits of the same code word on the FF array 813 are neither a combination of bits to be stored in cells in the same row of the FF array 815 nor a combination of bits to be stored in cells in the same column or adjacent columns of the FF array 815. Specifically, in the present embodiment, the reordering section 414 reorders arrays A1 to A3 into arrays B1 to B3 as shown in FIG. 14. The reordering is performed one by one. Accordingly, by connecting the parallel output terminal of each cell of the FF array 813 with the parallel input terminal of the corresponding cell of the FF array 815 by wiring, desired reordering can be performed.

Next, operation of the signal transmission circuit 810 according to the present embodiment will be described.

To the signal transmission circuit 810, time series signals as shown in FIG. 3 are input. The code word generation section 811 of the signal transmission circuit 810 serially receives the words input in the order as shown in FIG. 3 in synchronization with the clock, generates a 3-bit ECC code for correcting errors of the 4 bits constituting a word, and outputs a code word having a total of 7 bits to the conversion section 812.

The conversion section 812 inputs code words, output from the code word generation section 811, to the FF array 813 in synchronization with the clock. Then, when 5 pieces of continuous code words are input to the FF array 813, a total of 35 bits, read from the FF array 813, are reordered by the reordering section 814, and are stored in the FF array 815. Then, the conversion section 812 applies a right shift to the FF array 815 in synchronization with the clock. Thereby, a bit string, output from the FF array 815, is output to the signal lines 131-1, 131-2, and 132.

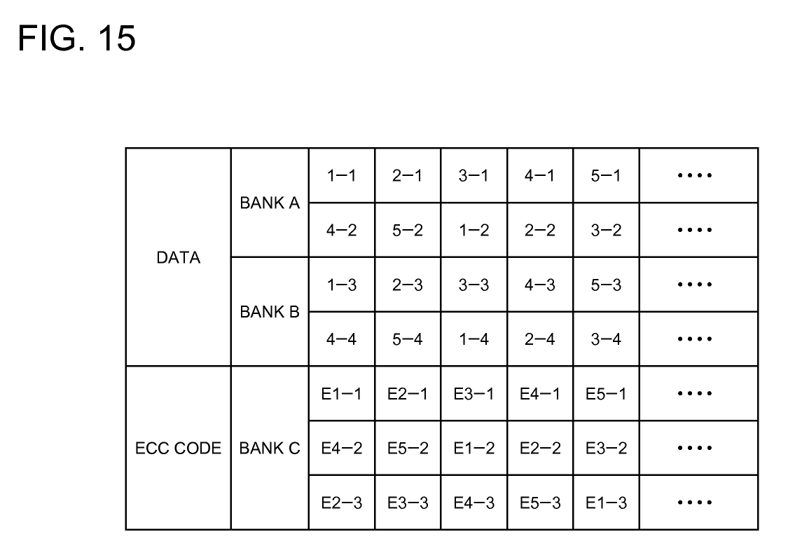

FIG. 15 is a time series of bit strings output from the FF array 815 to the signal line groups. As shown in FIG. 15, in the present embodiment, the bits constituting a code word are two-dimensionally arranged with respect to the parallel transmission direction of the signal line group and the time direction by each power bank, and the bits output at the same time and the bits output to the same signal line are mere 1 bit per code word. Accordingly, it is possible to ensure error correction capability with respect to both simultaneous switching errors and multiple errors on a particular signal line.

Further, in the present embodiment, for each power bank, the bits constituting the same code word are not output continuously but are output every other bit. As such, even if an error occurs in two continuing words due to huge simultaneous switching noise, as the respective bits belong to different code words, the error can be corrected. While in the present invention outputting is performed every other bit, it is needless to say that the effect can be enhanced with a coding format in which outputting is performed every two bits or every three bits.

Further, in the present embodiment, the information bits of 5 words and the entire bits of the ECC codes of those words can be transmitted in the unit of 5×7 bits. As such, the present embodiment is particularly suitable for transmission of burst data.

### Ninth Exemplary Embodiment

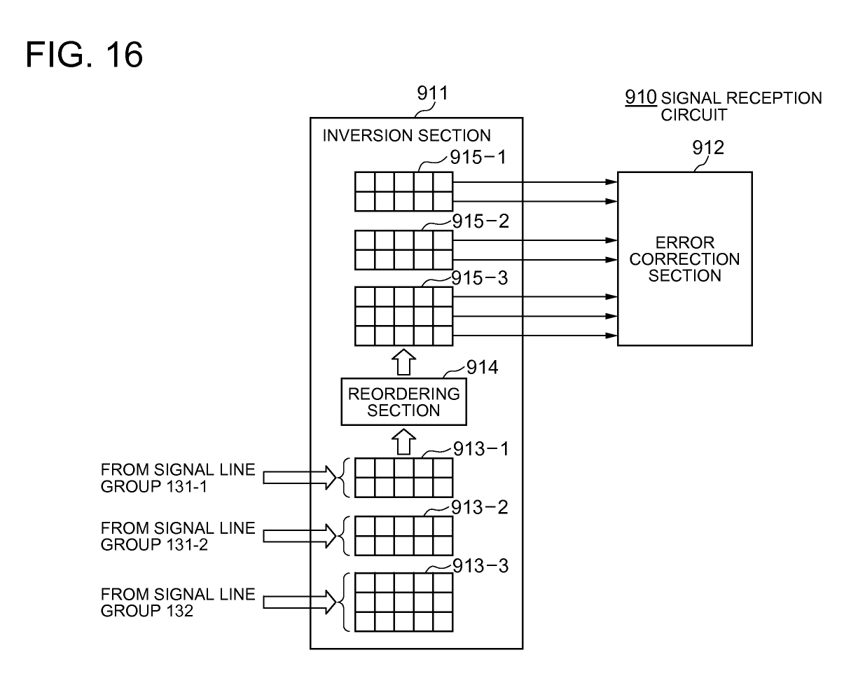

Referring to FIG. 16, a signal reception circuit 910 according to a ninth exemplary embodiment of the present invention includes an inversion section 911 and an error correction section 912. Hereinafter, the configuration of each of the sections will be described using, as an example, a hamming code in which the number of bits of a word is 4 bits and the number of bits of an ECC code is 3 bits. Further, the signal line group 131 connected with the signal transmission circuit 910 is divided into a signal line group 131-1 belonging to a power bank A and a signal line group 131-2 belonging to a power bank B. Further, the signal line group 132 belongs to another power bank C.

The inversion section 911 includes an FF array 913, a reordering section 914, and an FF array 915.

The FF array 913 is formed of three FF arrays 913-1 to 913-3. Each of the FF arrays 913-1 to 913-3 includes a plurality of cells. Each cell is formed of one flip flop. The FF array 913-1 is associated with the signal line group 131-1, and includes 2×5 cells. The FF array 913-2 is associated with the signal line group 131-2, and includes 2×5 cells. The FF array 913-3 is associated with the signal line group 132, and includes 3×5 cells. The inversion section 911 receives respective bits constituting code words from the signal lines 131-1, 131-2, and 132 in synchronization with the clock. The respective bits of code words, input to the inversion section 911, are input to the cells in the first columns of the respective rows of the FF arrays 913-1 to 913-3. In this step, the bit information stored in each cell is moved to a cell in the next column, and the pieces of bit information stored in the cells in the last columns are discarded. As such, each row of the FF arrays 913-1 to 913-3 constitutes a shift register. Further, the pieces of bit information stored in the cells of the FF arrays 913-1 to 913-3 can be read in parallel. In the present embodiment, every 5 clocks, a total of 35 bits are read from the entire cells of the FF arrays 913-1 to 913-3 by the reordering section 914.

The FF array 915 is formed of three FF arrays 915-1 to 915-3. Each of the FF arrays 915-1 to 915-3 includes a plurality of cells. Each cell is formed of one flip flop. Each of the FF arrays 915-1 and 915-2 includes 2×5 cells. The FF array 915-3 includes 3×5 cells. To the cells of each of the FF arrays 915-1 to 915-3, bit information can be written in parallel. The pieces of bit information written in the respective cells of the FF arrays 915-1 to 915-3 may be shifted in the row direction. When each of the FF arrays 915-1 to 915-3 is shifted by one to the right, the pieces of bit information stored in the respective columns are moved to the cells in the next column, and the information bits stored in the cells in the last columns are output to the error correction section 912 as one code word.

For each of a set of the FF array 913-1 and the FF array 915-1, a set of the FF array 913-2 and the FF array 915-2, and a set of the FF array 913-3 and the FF array 915-3, the reordering section 914 reorders the bits read from the FF array 913, and stores them in the FF array 915. When reordering, the reordering section 914 reorders the bits in such a manner that the bits in the same code word on the FF array 913 are stored in cells in the same column of the FF array 915. Specifically, in the present embodiment, the reordering section 514 reorders the arrays B1 to B3 into the arrays A1 to A3 as shown in FIG. 14. The reordering is performed one by one. Accordingly, by connecting the parallel output terminal of each cell of the FF array 913 with the parallel input terminal of the corresponding cell of the FF array 915 by wiring, desired reordering can be performed.

Next, operation of the signal reception circuit 910 according to the present embodiment will be described.

To the signal reception circuit 910, time series signals as shown in FIG. 15 are input via the signal line groups 131-1, 131-2, and 132. The inversion section 911 of the signal reception circuit 910 serially inputs the bit strings, input in the order as shown in FIG. 15, to the FF array 913 in synchronization with the clock. Then, when 5 pieces of continuous code words are input to the FF array 913, a total of 35 bits, read from the FF array 913, are reordered by the reordering section 914, and are stored in the FF array 915. Then, the inversion section 911 applies a right shift to the FF array 915 in synchronization with the clock. Thereby, a bit string, output from the FF array 915, is output to the error correction section 912 as one code word.

Each time a new code word is input, the error correction section 912 performs error checking of the code word. Then, if detecting an error of 1 bit, the error correction section 912 corrects the error, and outputs the word in which the error has been corrected.

According to the present embodiment, it is possible to provide a signal reception circuit which can be used in combination with the signal transmission circuit of the eighth exemplary embodiment.

### Tenth Exemplary Embodiment

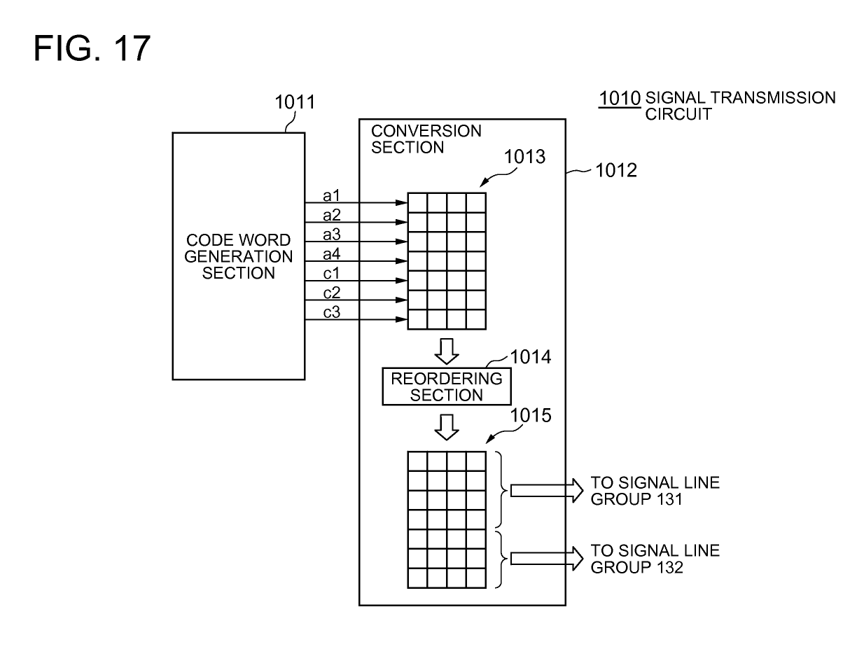

Referring to FIG. 17, a signal transmission circuit 1010 according to a tenth exemplary embodiment of the present invention includes a code word generation section 1011 and a conversion section 1012. Hereinafter, the configuration of each of the sections will be described using, as an example, a hamming code in which the number of bits of a word is 4 bits and the number of bits of an ECC code is 3 bits.

The code word generation section 1011 receives 4 bits constituting a word in synchronization with the clock, generates a 3-bit ECC code from the 4 bits, and outputs, to the conversion section 1012, a code word constituted of a total of 7 bits including the 4 bits a1, a2, a3, and a4 constituting the input word and the 3 bits c1, c2, and c3 constituting the generated ECC code.

The conversion section 1012 includes an FF array 1013, a reordering section 1014, and an FF array 1015.

The FF array 1013 includes 7×4 pieces of cells. Each cell is formed of one flip flop. The conversion section 1012 receives respective bits constituting code words from the code word generation section 1011 in synchronization with the clock. The respective bits of each code word, input to the conversion section 1012, are input to the cells C_{1,1}, C_{2,1}, C_{3,1}, C_{4,1}, C_{5,1}, C_{6,1}, and C_{7,1} in the first column of the respective rows of the FF array 1013. In this step, the bit information stored in each cell is moved to a cell in the next column, and the pieces of bit information stored in the cells C_{1,4}, C_{2,4}, C_{3,4}, C_{4,4}, C_{5,4}, C_{6,4}, and C_{7,4} in the last column are discarded. As such, each row of the FF array 1013 constitutes a shift register. Further, the pieces of bit information stored in the cells of the FF array 1013 can be read in parallel. In the present embodiment, every 4 clocks, a total of 28 bits are read from the entire cells by the reordering section 1014.

The FF array 1015 includes 7×4 pieces of cells. Each cell is formed of one flip flop. To the cells of the FF array 1015, bit information can be written in parallel. The pieces of bit information written in the respective cells of the FF array 1015 may be shifted in the row direction. When the FF array 1015 is shifted by one to the right, the pieces of bit information stored in the respective columns are moved to the cells in the next column, the information bits stored in the cells C_{1,4}, C_{2,4}, C_{3,4}, and C_{4,4} in the last column are output to the signal line 131, and the code bits stored in the cells C_{5,4}, C_{6,4}, and C_{7,4}, in the last column are output to the signal line 132.

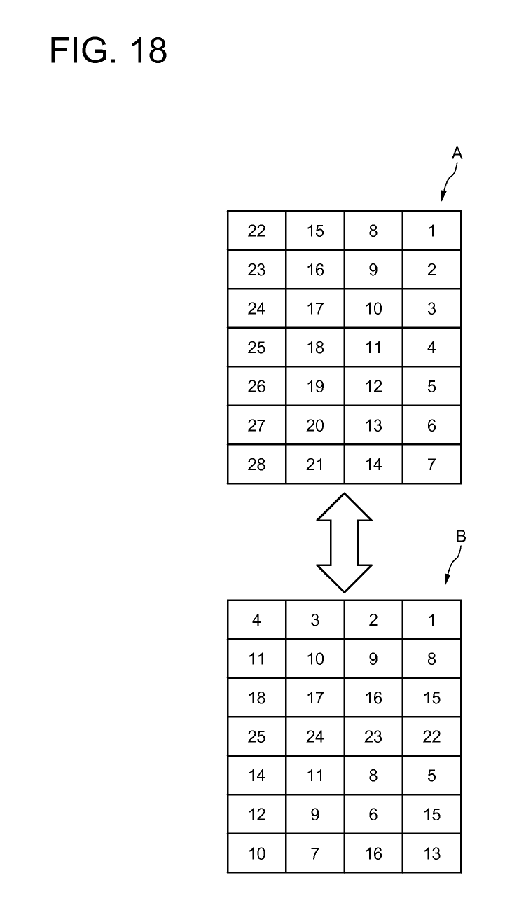

The reordering section 1014 reorders the 28 bits of the 4 code words read from the FF array 1013, and stores them in the FF array 1015. When reordering, by each power bank, the reordering section 1014 reorders the bits in such a manner that a combination of any 2 bits in the same code word on the FF array 1013 are not a combination of bits to be stored in cells in the same column of the FF array 1015. Specifically, in the present embodiment, the reordering section 414 reorders an array A into an array B as shown in FIG. 18. The reordering is performed one by one. Accordingly, by connecting the output terminal of each cell of the FF array 1013 with the parallel input terminal of the corresponding cell of the FF array 1015 by wiring, desired reordering can be performed.

Next, operation of the signal transmission circuit 1010 according to the present embodiment will be described.

To the signal transmission circuit 1010, time series signals as shown in FIG. 3 are input. The code word generation section 1011 of the signal transmission circuit 1010 serially receives the words input in the order as shown in FIG. 3 in synchronization with the clock, generates a 3-bit ECC code for correcting errors of the 4 bits constituting a word, and outputs a code word having a total of 7 bits to the conversion section 1012.

The conversion section 1012 inputs code words, output from the code word generation section 1011, to the FF array 1013 in synchronization with the clock. Then, when 4 pieces of continuous code words are input to the FF array 1013, a total of 28 bits, read from the FF array 1013, are reordered by the reordering section 1014, and are stored in the FF array 1015. Then, the conversion section 1012 applies a right shift to the FF array 1015 in synchronization with the clock. Thereby, a bit string, output from the FF array 1015, is output to the signal line groups 131 and 132.

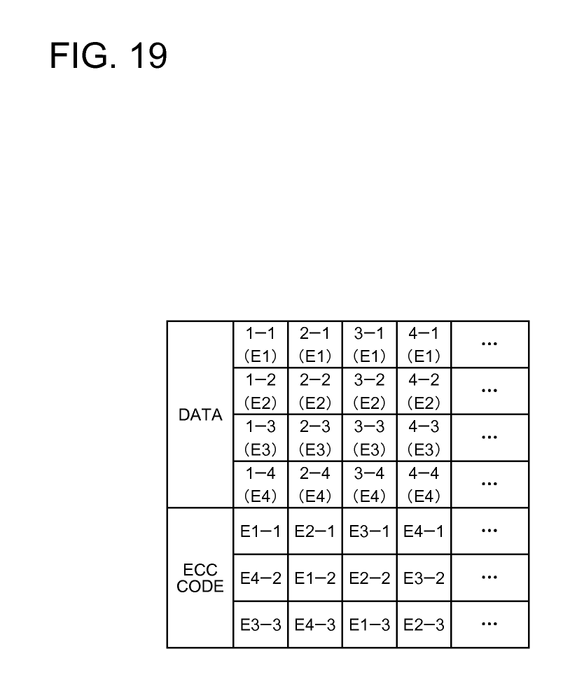

FIG. 19 is a time series of bit strings output from the FF array 1015 to the signal line groups. As shown in FIG. 19, in the present embodiment, the bits output at the same time are mere 1 bit per code word by each power bank. Accordingly, it is possible to ensure error correction capability with respect to simultaneous switching errors.

Further, in the present embodiment, the bits output to the same signal line are mere 1 bit per code word. Accordingly, it is possible to ensure error correction capability with respect to multiple errors on a particular signal line.

Further, in the present embodiment, the information bits of 4 words and the entire bits of the ECC codes for those words can be transmitted in the unit of 28 bits. As such, the present embodiment is particularly suitable for transmission of burst data.

### Eleventh Exemplary Embodiment

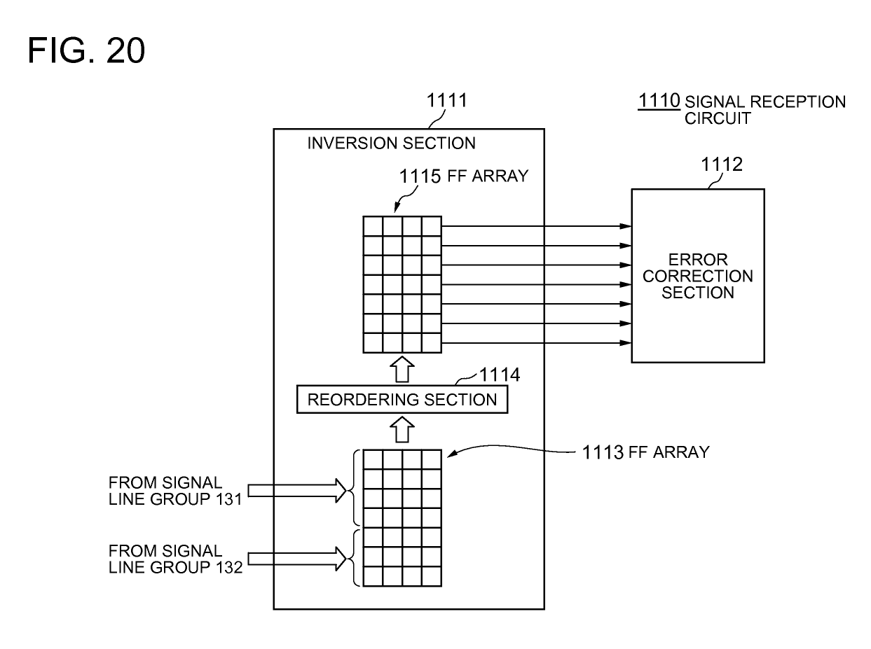

Referring to FIG. 20, a signal reception circuit 1110 according to an eleventh exemplary embodiment of the present invention includes an inversion section 1111 and an error correction section 1112. Hereinafter, the configuration of each of the sections will be described using, as an example, a hamming code in which the number of bits of a word is 4 bits and the number of bits of an ECC code is 3 bits. Further, the signal line group 131 connected with the signal reception circuit 1110 belongs to a power bank A, and the signal line group 132 belongs to another power bank B.

The inversion section 1111 includes an FF array 1113, a reordering section 1114, and an FF array 1115.

The FF array 1113 includes 7×4 pieces of cells. Each cell is formed of one flip flop. The inversion section 1111 receives bit strings from the signal line groups 131 and 132 in synchronization with the clock. A bit string, input to the inversion section 1111, is input to the cells C_{1,1}, C_{2,1}, C_{3,1}, C_{4,1}, C_{5,1}, C_{6,1}, and C_{7,1} in the first column of the respective rows of the FF array 1113. In this step, the bit information stored in each cell is moved to a cell in the next column, and the pieces of bit information stored in the cells C_{1,4}, C_{2,4}, C_{3,4}, C_{4,4}, C_{5,4}, C_{6,4}, and C_{7,4} in the last column are discarded. As such, each row of the FF array 1113 constitutes a shift register. Further, the pieces of bit information stored in the cells of the FF array 1113 can be read in parallel. In the present embodiment, every 4 clocks, a total of 28 bits are read from the entire cells by the reordering section 1114.

The FF array 1115 includes 7×4 pieces of cells. Each cell is formed of one flip flop. To the cells of the FF array 1115, bit information can be written in parallel. The pieces of bit information written in the respective cells of the FF array 1115 may be shifted in the row direction. When the FF array 1115 is shifted by one to the right, the pieces of bit information stored in the respective columns are moved to the cells in the next column, and the bit string stored in the cells C_{1,4}, C_{2,4}, C_{3,4}, C_{4,4}, C_{5,4}, C_{6,4}, and C_{7,4}, in the last column are output to the error correction section 1112 as one code word.

The reordering section 1114 reorders the 28 bits of the 4 code words read from the FF array 1113, and stores them in the FF array 1115. When reordering, the reordering section 1114 reorders the bits in such a manner that the bits of the same code word on the FF array 1113 are stored in cells in the same column of the FF array 1115. Specifically, in the present embodiment, the reordering section 1114 reorders the array B into the array A as shown in FIG. 18. The reordering is performed one by one. Accordingly, by connecting the output terminal of each cell of the FF array 1113 with the parallel input terminal of the corresponding cell of the FF array 1115 by wiring, desired reordering can be performed.

Next, operation of the signal reception circuit 1110 according to the present embodiment will be described.

To the signal reception circuit 1110, time series signals as shown in FIG. 19 are input via the signal line groups 131 and 132. The inversion section 1111 of the signal reception circuit 1110 serially inputs the bit strings, input in the order as shown in FIG. 19, to the FF array 1113 in synchronization with the clock. Then, when 4 pieces of continuous code words are input to the FF array 1113, a total of 28 bits, read from the FF array 1113, are reordered by the reordering section 1114, and are stored in the FF array 1115. Then, the inversion section 1111 applies a right shift to the FF array 1115 in synchronization with the clock. Thereby, a bit string, output from the FF array 1115, is output to the error correction section 1112 as one code word.

Each time a new code word is input, the error correction section 1112 performs error checking of the code word. Then, if detecting an error of 1 bit, the error correction section 1112 corrects the error, and outputs the word in which the error has been corrected.

According to the present embodiment, it is possible to provide a signal reception circuit which can be used in combination with the signal transmission circuit of the tenth exemplary embodiment.

### Twelfth Exemplary Embodiment

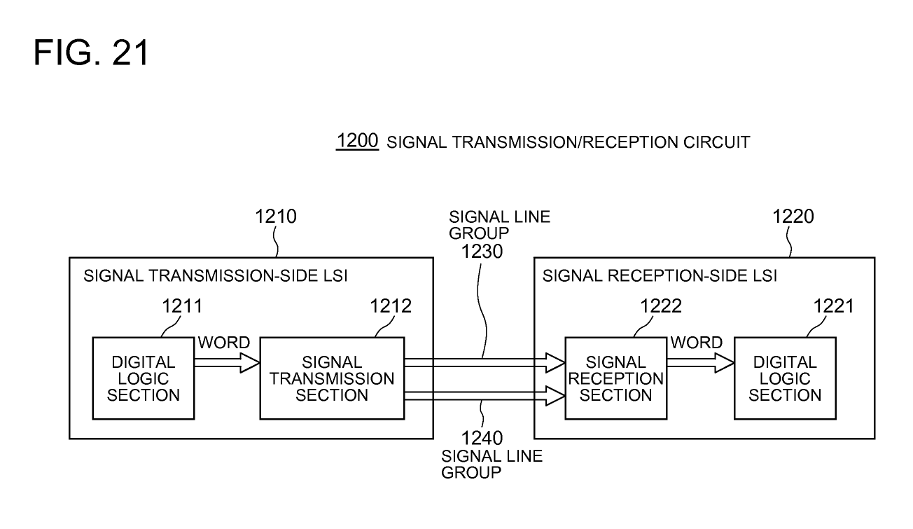

Referring to FIG. 21, a signal transmission/reception circuit 1200 according to a twelfth exemplary embodiment of the present invention includes a signal transmission-side LSI 1210, and a signal reception-side LSI 1220 connected with the signal transmission-side LSI 1210 via a signal line group 1230 and a signal line group 1240. The signal line group 1230 may be a data bus for example, including a plurality of signal lines. The signal line group 1240 includes a plurality of signal lines for transmitting ECC codes.

The signal transmission-side LSI 1210 includes a digital logic section 1211 and a signal transmission section 1212. The signal reception-side LSI 1220 includes a digital logic section 1221 and a signal reception section 1222. Each of the digital logic sections 1211 and 1221 is formed of an MPU (Micro-Processing Unit) or the like. When the digital logic section 1211 transmits data to the digital logic section 1221, the digital logic section 1211 outputs data in word units to the signal transmission section 1212.

The signal transmission section 1212 has a function of serially receiving a plurality of words from the digital logic section 1211, from the words, generating a plurality of code words each formed of information bits, having the same number of bits as those of the word, and an ECC code, and transmitting them to the signal reception circuit 1220 via the signal line groups 1230 and 1240. The signal transmission section 1212 may be formed of the signal transmission circuit according to the first, second, fourth, sixth, eighth, or the tenth exemplary embodiment described above.

The signal reception section 1222 has a function of receiving a plurality of code words from the signal transmission circuit 1210 via the signal line groups 1230 and 1240, and for each of the received code words, performing error correction of the information bits using the ECC code, and outputting the data constituted of the information bits in which the errors have been corrected to the digital logic section 1221 in word units. The signal reception section 1222 may be formed of the signal reception circuit according to the first, third, fifth, seventh, ninth, and eleventh exemplary embodiment described above.

### Thirteenth Exemplary Embodiment

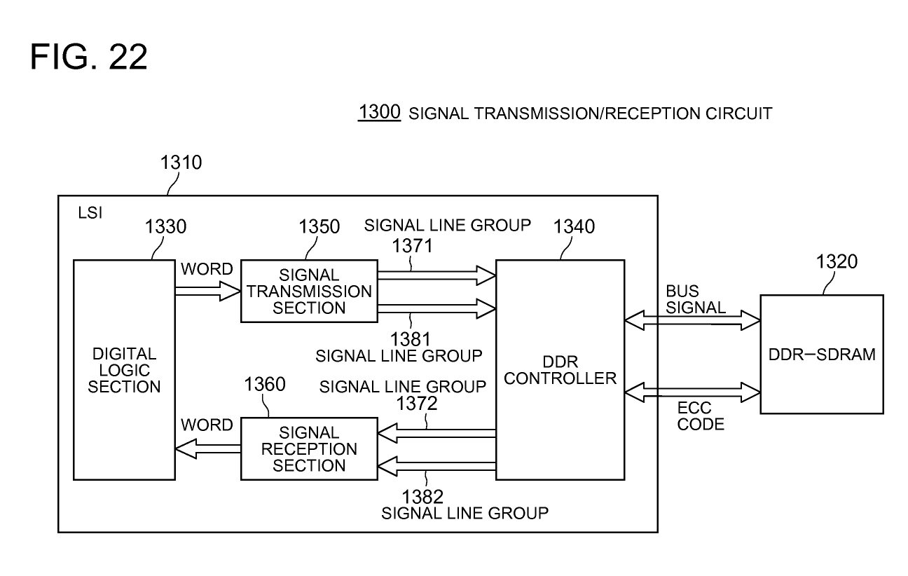

Referring to FIG. 22, a signal transmission/reception circuit 1300 according to a thirteenth exemplary embodiment of the present invention includes an LSI 1310, and a DDR-SDRAM (Double-Data-Rate Synchronous Dynamic Random Access Memory) 1320 which transmits and receives bus signals and ECC codes with the LSI 1310. Further, the LSI 1310 includes a digital logic section 1330 formed of an MPU or the like, a DDR controller 1340, and a signal transmission section 1350 and a signal reception section 1360 provided between the digital logic section 1330 and the DDR controller 1340.

The signal transmission section 1350 has a function of serially receiving a plurality of words from the digital logic section 1330, generating, from the words, a plurality of code words each formed of information bits, having the same number of bits as those of the word, and an ECC code, and transmitting them to the DDR controller 1340 via signal line groups 1371 and 1381. The signal transmission section 1350 may be formed of the signal transmission circuit according to the first, second, fourth, sixth, eighth, or the tenth exemplary embodiment described above.

The signal reception section 1360 has a function of receiving a plurality of code words from the DDR controller 1340 via signal line groups 1372 and 1382, and for each of the received code words, performing error correction of the information bits using the ECC code, and outputting the data constituted of the information bits in which the errors have been corrected to the digital logic section 1330 in word units. The signal reception section 1360 may be formed of the signal reception circuit according to the first, third, fifth, seventh, ninth, and eleventh exemplary embodiment described above.

While the present invention has been described with reference to the exemplary embodiments, the present invention is not limited to these exemplary embodiments, and various additions and changes may be made therein. Further, in order to simplify the description, while the respective exemplary embodiments have been described based on an example of adding a 3-bit ECC code to a 4-bit word, the number of bits of a word is not limited to 4 bits. Any number of bits, including 8 bits, 16 bits, 32 bits, and 64 bits may be acceptable. Further, an ECC code may also have any number of bits, according to the number of bits of the word and the error checking and correcting capability.

### INDUSTRIAL APPLICABILITY

The present invention is applicable to the overall field of transmitting and receiving signals in parallel data by adding ECC codes, between LSIs, between an LSI and a RAM, or the like.

### REFERENCE NUMERALS

100 signal transmission/reception circuit
110 signal transmission circuit
111 code word generation section
112 conversion section
120 signal reception circuit
121 inversion section
122 error correction section
130, 131, 132 signal line group

1. A signal transmission and reception circuit comprising a signal transmission circuit and a signal reception circuit connected with each other by a first signal line group and a second signal line group, wherein
the signal transmission circuit includes:
a code word generation section that generates a code word by adding an error checking and correcting code to an input word; and
a conversion section that divides a plurality of code words generated by the code word generation section into bit strings each including information bits having the number of bits which is the same as the number of bits of the word and code bits having the number of bits which is the same as the number of bits of the error checking and correcting code, and for each of the bit strings, outputs the information bits of the bit string to the first signal line group and outputs the code bits of the bit string to the second signal line group, wherein when dividing the code words into the bit strings, the conversion section divides the code words in such a manner as to satisfy a condition that a plurality of bits of the same code word are not output at the same time within a range of the first signal line group and the second signal line group or a range of a partial signal line group included in the first signal line group and the second signal line group, and that respective bits of an error checking and correcting code of the same code word are output to different signal lines of the second signal line group, respectively, and
the signal reception circuit includes:
an inversion section that reorders the bit strings received from the first signal line group and the second signal line group to reproduce the code words in each of which the error checking and correcting code is added to the word; and
an error correction section that performs error correction of the word with use of the error checking and correcting code included in the code word reproduced by the inversion section, and outputs the word to the outside in a word unit.

2. The signal transmission and reception circuit according to claim 1, wherein
when dividing the code words into the bit strings, the conversion section divides the code words in such a manner that a combination of any 2 bits of the same code word are not output at the same time within the range of the first signal line group and the second signal line group or a range of a partial signal line group included in the first signal line group and the second signal line group.

3. The signal transmission and reception circuit according to claim 1, wherein
the partial signal line group is a group of signal lines in which drive circuits driving the signal lines use the same power source.

4. A signal transmission circuit connected with a first signal line group and a second signal line group, comprising:
a code word generation section that generates a code word by adding an error checking and correcting code to an input word; and
a conversion section that divides a plurality of code words generated by the code word generation section into bit strings each including information bits having the number of bits which is the same as the number of bits of the word and code bits having the number of bits which is the same as the number of bits of the error checking and correcting code, and for each of the bit strings, outputs the information bits of the bit string to the first signal line group and outputs the code bits of the bit string to the second signal line group, wherein when dividing the code words into the bit strings, the conversion section divides the code words in such a manner as to satisfy a condition that a plurality of bits of the same code word are not output at the same time within a range of the first signal line group and the second signal line group or a range of a partial signal line group included in the first signal line group and the second signal line group, and that respective bits of an error checking and correcting code of the same code word are output to different signal lines of the second signal line group, respectively.

5. The signal transmission circuit according to claim 4, wherein
when dividing the code words into the bit strings, the conversion section divides the code words in such a manner that a combination of any 2 bits of the same code word are not output at the same time within the range of the first signal line group and the second signal line group or a range of a partial signal line group included in the first signal line group and the second signal line group.

6. The signal transmission circuit according to claim 4, wherein
the partial signal line group is a group of signal lines in which drive circuits driving the signal lines use the same power source.

7. A signal reception circuit that receives bit strings transmitted from the signal transmission circuit according to claim 4 via a first signal line group and a second signal line group, comprising:
an inversion section that reorders the bit strings received from the first signal line group and the second signal line group to reproduce code words in each of which an error checking and correcting code is added to a word; and
an error correction section that performs error correction of the word with use of the error checking and correcting code included in the code word reproduced by the inversion section, and outputs the word to the outside in a word unit.

8. A signal transmission and reception method implemented by a signal transmission and reception circuit including a signal transmission circuit and a signal reception circuit connected with each other by a first signal line group and a second signal line group, the signal transmission circuit including a code word generation section and a conversion section, the signal reception circuit including an inversion section and an error correction section, the method comprising:
by the code word generation section, generating a code word by adding an error checking and correcting code to an input word;
by the conversion section, dividing a plurality of code words generated by the code word generation section into bit strings each including information bits having the number of bits which is the same as the number of bits of the word and code bits having the number of bits which is the same as the number of bits of the error checking and correcting code, and for each of the bit strings, outputting the information bits of the bit string to the first signal line group and outputting the code bits of the bit string to the second signal line group, the dividing the code words into the bit strings being performed in such a manner as to satisfy a condition that a plurality of bits of the same code word are not output at the same time within a range of the first signal line group and the second signal line group or a range of a partial signal line group included in the first signal line group and the second signal line group, and that respective bits of an error checking and correcting code of the same code word are output to different signal lines of the second signal line group, respectively;
by the inversion section, reordering the bit strings received from the first signal line group and the second signal line group to reproduce the code words in each of which the error checking and correcting code is added to the word; and
by the error correction section, performing error correction of the word with use of the error checking and correcting code included in the code word reproduced by the inversion section, and outputs the word to the outside in a word unit.
